(19) United States
(12) Patent Application Publication
(10) Pub. No.: US 2014/0028861 A1
(43) Pub. Date: Jan. 30, 2014

(54) OBJECT DETECTION AND TRACKING

(71) Applicant: David Holz, San Francisco, CA (US)

(72) Inventor: David Holz, San Francisco, CA (US)

(21) Appl. No.: 13/952,226

(22) Filed: Jul. 26, 2013

Related U.S. Application Data
(60) Provisional application No. 61/676,104, filed on Jul. 26, 2012.
(60) Provisional application No. 61/794,046, filed on Mar. 15, 2013.

(51) Int. Cl. H04N 5/232

(52) U.S. Cl. CPC H04N 5/23277
USPC 348/208.4

(57) ABSTRACT

Imaging systems and methods improve object recognition by more strongly enhancing contrast between the object and non-object (e.g., background) surfaces than would be possible with a simple optical filter tuned to the wavelength(s) of the source light(s). In some embodiments, the overall scene illuminated by ambient light is preserved (or may be reconstructed) for presentation purposes—e.g., combined with a graphical overlay of the sensed object(s) in motion.

### CROSS-REFERENCE TO RELATED APPLICATIONS

This application claims priority to, and the benefits of, U.S. Ser. No. 61/676,104, filed on Jul. 26, 2012, and U.S. Ser. No. 61/794,046, filed on Mar. 15, 2013. The foregoing applications are incorporated herein by reference in their entireties.

### TECHNICAL FIELD

The present disclosure relates generally to imaging systems and in particular to three-dimensional (3D) object detection, tracking and characterization using optical imaging.

### BACKGROUND

Optical imaging systems are becoming popular in a variety of applications to obtain information about objects in various settings. In a typical setup, a source light illuminates the object(s) of interest so that the object(s) are detected based on reflected source light, which is sensed by camera directed at the scene. Such systems generally include mechanisms (e.g., vision system) to analyze the images to obtain information about the target object(s). Conventionally, optical imaging systems rely on favorable conditions, e.g., optical differences between objects and background, in order to successfully distinguish an object of interest in the image.

Unfortunately, such conventional approaches suffer performance degradation under many common circumstances, e.g., low contrast between the object of interest and the background and/or patterns in the background that may falsely register as object edges. This may result, for example, from reflectance similarities, i.e., under general illumination conditions, the chromatic reflectance of the object of interest is so similar to that of surrounding or background objects that it cannot easily be isolated. Therefore, what is really needed are better techniques for determining information about target object(s) including object(s) having relatively low contrast compared with the background against which the object is studied.

### SUMMARY

Aspects of the embodiments described herein provide for improved image based recognition, tracking of conformation and/or motion, and/or characterization of objects (including objects having one or more articulating members (i.e., humans and/or animals and/or machines) advantageously applicable in situations in which contrast between object(s) and/or object(s) and background is limited and/or viewing conditions are less than optimal (high reflectivity, environmental noise, low contrast, etc.). Among other aspects, embodiments can enable selectively controlling light characteristics in conjunction with automatically (e.g., programmatically) reconstructing an object's characteristics (e.g., position, volume, surface characteristics, and/or motion) from one or a sequence of images. Embodiments can enable improvements in receiving input, commands, communications and/or other user-machine interfacing, gathering information about objects, events and/or actions existing or occurring within an area being explored, monitored, or controlled, and/or combinations thereof.

Among other aspects, an embodiment provides a method of improving an image of an object suitable for machine control. The method can include illuminating the object with electromagnetic radiation having a first optical characteristic. Optical characteristics can include values, properties, and/or combinations thereof (e.g., frequency, wavelength of 850 nM, circular polarization, etc.). The method further includes selectively sensitizing a first subset of optically sensitive picture elements of a sensor to the first optical characteristic and selectively sensitizing a second subset of optically sensitive picture elements of the sensor to a second optical characteristic. Capturing an image of the object is also part of the method. The image includes a first image information subset derived from the first subset of optically sensitive picture elements and a second image information subset derived from the second subset of optically sensitive picture elements. The method can also include removing noise from the image to form an improved image by determining a difference between the first image information subset and the second image information subset. The improved image can be used to determine gesture information for controlling a machine (e.g., computer(s), tablets, cell phones, industrial robots, medical equipment and so forth).

Removing noise from the image can include, for example, comparing amplitude ratios between corresponding pixels of the first image information subset and the second image information subset captured by different sets of sensor picture elements.

Sensitizing subset(s) of optically sensitive picture elements of an image sensor is performed in a variety of ways in various embodiments, (e.g., hardware, software, firmware, custom sensor configurations, and/or combinations thereof). In one embodiment sensitizing can include controlling a subset of optically sensitive picture elements of the sensor to respond electrically to electromagnetic radiation having a wavelength including at least the first optical characteristic. In another embodiment, sensitizing can include applying one or more filter(s) to a set(s) of alternating pixel rows and/or columns in an interlaced fashion, or in a mixed axis pattern (e.g., an RGB, CMYK, or RGBG pattern).

According to one aspect, in some embodiments one or more filters can be applied to an image sensor, and/or portions of the image sensor, of an imaging device (e.g., camera, scanner, or other device capable of producing information representing an image). Filters targeted to specific pixels (e.g., pixel rows, and/or columns) of the sensor enable embodiments to achieve improved control over the imaging process. In one embodiment, two or more types of filter are used in conjunction with the sensor pixels in, for example, row-interlaced form. A first filter type (e.g., those applicable to even pixel rows or columns) allows transmission of wavelengths associated with a source light(s). A second filter type (e.g., those applicable to odd pixel rows or columns) does not allow the transmission of wavelengths associated with the source light(s). The images captured by the differently filtered sets of pixels can be used to determine which pixels correspond to an object in the field of view. (e.g., images can be compared and the image corresponding to pixels acted upon by the second filter type can be used to remove noise from the image corresponding to pixels acted upon by the first filter type). This may be accomplished, for example, using the ratio between the two images (i.e., taking the pixel-by-pixel amplitude ratios and eliminating, from the first image, pixels whose ratio falls below a threshold).

Embodiments can employ filters of varying properties to exclude “noise” wavelengths in conjunction with a source of illumination emitting radiant energy in wavelengths centered about a dominant emission wavelength λ. For example, one embodiment includes a first type of filter configured to pass wavelengths greater (i.e., longer than) a threshold wavelength, which is typically slightly shorter than λ, (i.e., the threshold wavelength is λ−δ₁), and a second type of filter configured to pass wavelengths more than a threshold amount below (i.e., shorter than) the dominant source wavelength λ, (i.e., the second type of filter passes only wavelengths below λ−δ₂,). (Typically, δ₂>δ₁). Alternatively, the first type of filter may pass only wavelengths shorter than a threshold wavelength, which is itself typically slightly longer than λ, while the second filter passes only wavelengths more than a threshold amount above (i.e., longer than) the source wavelength λ. In still another alternative, the second type of filter may pass wavelengths more than a threshold amount above λ; whereas the first filter passes wavelengths above λ−δ₁, as before, the second type of filter passes wavelengths above λ+δ₂. Typically, the second-filter threshold equals or exceeds the first-filter threshold (i.e., δ₂≧67 ₁). Variants exist, however, and in embodiments, filters may be applied row-wise and/or column-wise and/or can conform to any mixed-axis pattern suitable to a particular application. Likewise, filters need not be unitary in nature, but can be individual to each pixel or group of pixels, may be mechanical, electro-mechanical, and/or algorithmic in nature and implemented in hardware, firmware, software and/or combinations thereof, and may be associated with micro-lenses and/or other optical elements. It may also be advantageous in some applications to apply different filters to different relative numbers of pixels; enabling creation of images having different resolutions. Moreover, the term “filter” as used herein broadly connotes any means, expedient, computer code or process steps for performing a “filter function”, i.e., obtaining an output having an optical characteristic or property (e.g., polarization, frequency, wavelength, other property and/or combinations thereof) composition different from an input. Filters advantageously employed in embodiments can include absorptive filters, dichroic filters, monochromatic filters, infrared filters, ultraviolet filters, neutral density filters, longpass filters, bandpass filters, shortpass filters, guided-mode resonance filters, metal mesh filters, polarizing filters, and/or other means, expedient or steps that is selectively transmissive to light of certain properties but non-transmissive to light of other properties. A filter selectively transmits light of certain characteristic or property (e.g., wavelengths or wavelength bands) of light, which may be implemented using an optical device, electrically and/or in logic using circuitry, electrical hardware and/or firmware, and/or in software, and/or combinations thereof.

In one embodiment, an image capture and analysis system includes a camera oriented toward a field of view. The camera includes an image sensor having an array of light-sensing pixels. The system includes a first type of filter applicable to a first plurality of the pixels. The system further includes a second type of filter applicable to a second plurality of pixels, that is different from the first plurality of pixels, and that provides an image optically different from an image taken with the first type of filter. The system also includes an image analyzer coupled to the camera. The image analyzer can be configured to capture (i.e., using the camera) a plurality of images, e.g., a first image corresponds to the first plurality of pixels and a second image corresponding to the second plurality of pixels. The analyzer can also be configured to determine pixels corresponding to an object of interest in the field of view based at least in part upon the first image and the second image.

According to another aspect, the invention pertains to a method of improving an image of an object for machine control; the method includes illuminating the object with electromagnetic radiation having a first optical characteristic (e.g., a wavelength, frequency, or polarization); selectively sensitizing a first subset of optically sensitive picture elements of a sensor to the first optical characteristic and selectively sensitizing a second subset of optically sensitive picture elements of the sensor to a second optical characteristic; capturing an image of the object, the image including a first image information subset derived from the first subset of optically sensitive picture elements and a second image information subset derived from the second subset of optically sensitive picture elements; and removing noise from the image to form an improved image by determining a difference between the first image information subset and the second image information subset. In one implementation, the method further includes analyzing the improved image to determine gesture information for controlling a machine.

In various embodiments, removing noise from the image is achieved by comparing amplitude ratios between corresponding pixels of the first image information subset and the second image information subset captured by different sets of sensor picture elements. Additionally, selectively sensitizing a first subset of optically sensitive picture elements of a sensor to the first optical characteristic and selectively sensitizing a second subset of optically sensitive picture elements of the sensor to a second optical characteristic includes applying a first filter to the first subset of optically sensitive picture elements of the sensor; the first filter permits detection of electromagnetic radiation having a wavelength proximate to the first optical characteristic. In one embodiment, the first filter is applied to the first subset of alternating pixel rows and/or columns in an interlaced fashion or in a mixed axis pattern. Illuminating the object with electromagnetic radiation having a first optical characteristic may include: illuminating with a light source having a dominant wavelength; and wherein the first filter permits detection of electromagnetic radiation having a wavelength proximate to the dominant wavelength; and applying a second filter that does not permit detection of the dominant wavelength to the second subset of optically sensitive picture elements of the sensor.

Selectively sensitizing a first subset of optically sensitive picture elements of a sensor to the first optical characteristic and selectively sensitizing a second subset of optically sensitive picture elements of the sensor to a second optical characteristic may be achieved by controlling a subset of optically sensitive picture elements of the sensor to respond electrically to electromagnetic radiation having a wavelength including at least the first optical characteristic and/or dynamically tuning a subset of optically sensitive picture elements of the sensor to respond electrically to electromagnetic radiation having a wavelength including at least the first optical characteristic.

According to a further aspect, the invention relates to a non-transitory machine readable medium, storing one or more instructions which when executed by one or more processors cause the one or more processors to perform the following: illuminating the object with electromagnetic radiation having a first optical characteristic; capturing an image of the object, the image including a first image information subset derived from selectively sensitizing a first subset of optically sensitive picture elements of a sensor to the first optical characteristic and a second image information subset derived from selectively sensitizing a second subset of optically sensitive picture elements of the sensor to a second optical characteristic; and removing noise from the image to form an improved image by determining a difference between the first image information subset and the second image information subset.

According to another aspect, some embodiments utilizes multiple light sources each emitting radiant energy at a different characteristic (e.g., polarization, frequency, wavelength, i.e., emitting a band of wavelengths centered about a wavelength λ, or other property of light). The light sources can be spaced apart by a known distance and have a known position relative to the camera(s). An image sensor includes various types of light-sensing pixels, each type of pixels being sensitive to a different dominant wavelength of light (e.g., a first type of sensor pixels is sensitive to wavelengths centered around λ₁; so that light emitted from a first light source or reflected or scattered from the object of interest can be detected by the first pixel type. Similarly, light emitted from a second light source, having a center wavelength λ₂ may be detected by the second pixel type and forms images thereon.) The different types of sensor pixels generate multiple sub-images, each associated with one pixel type. Any number of sub-images can then be combined (e.g., using an arithmetic and/or image-processing algorithm) to remove noise therefrom. The different pixel types may be arranged in a column-wise or row-wise fashion or may conform to any mixed-axis pattern.

In various embodiments, the multiple types of sensor pixels may be used in conjunction with multiple types of filters. For example, the first and second filters may have filter functions tuned to the emitted wavelengths (e.g., the filters may be narrowband filters that pass only one of the emitted wavelengths, and/or low-pass and/or high-pass filters with cutoffs corresponding to, or displaced from, the emitted wavelengths, and/or combinations thereof).

With the two different filters applied to different pixels (e.g., in an “interlaced” fashion with each filter type applied to alternating rows or columns), each set of pixels follows the light cast by a specific light source (or group of light sources emitting at a common wavelength). Knowing the position of each light source, motion can be estimated by comparing variations in the sensed light intensities for each channel over time; that is, the images recorded by the differently filtered pixel sets have different angular information embedded therein. The apparent edges will move around, providing richer information from which to deduce motion (e.g., using techniques described in co-pending U.S. Ser. Nos. 13/414,485, filed Mar. 7, 2012, and 61/587,554, filed Jan. 17, 2012, the entire disclosures of which are hereby incorporated by reference as if reproduced verbatim beginning here).

According to a further aspect, some embodiments use multiple successive exposures using different types, and/or different numbers of, light sources, for example, to provide varying effective exposure levels. These exposures are synchronized with the different light sources or light-source combinations, and the exposures can be compared to remove noise from a “base” image captured at an exposure level matched to the average luminance of the scene. This may be accomplished, for example, by subtracting a higher-contrast image from the base image. In effect, noise removal is accomplished by time multiplexing of the images rather than wavelength multiplexing of the light sources.

By rapidly acquiring separate images at different sensor settings and/or under different lighting conditions (or achieving the same result by an image manipulation such as tone mapping) normal-contrast and high-contrast images of the same scene may be obtained, with the latter used to remove noise from the former through subtraction or other image-comparison operation. The successive images are acquired sufficiently rapidly that, in a motion-capture context, relatively little or no object movement will have occurred between the images. One or more comparison images may be obtained in addition to the normal scene image, and the comparison images may differ from the base image (e.g., the number of lighting source active during exposure, and/or the type of lighting sources and/or the dynamic-range setting of the sensor). In one embodiment, a single high-contrast image is obtained in addition to the normal scene image, but various applications may benefit from a series of exposures with different levels of contrast, e.g., multiple high-contrast images with different degrees of saturation or images with contrast levels above and below the normal-contrast image.

In one embodiment, the overall scene illuminated by, for example ambient light; may be preserved or reconstructed for presentation purposes. This may be accomplished, for example, using a high-pass or low-pass filter whose cut-off wavelength is below or above the visible spectrum; the pixels receiving light through this filter will record the visible scene. Moreover, one embodiment uses a camera with an RGB-IR filter pattern, by employing the IR channel for motion sensing and the RGB channel for normal imaging.

Advantageously, embodiments can provide for enhancing contrast between target object(s) and non-object (e.g., background) surfaces than would be possible with a simple optical filter tuned to the wavelength(s) of the source light(s) for example. In some embodiments, the overall scene illuminated by ambient, for example, light can be preserved (or may be reconstructed) for presentation purposes (e.g., combined with a graphical overlay of the sensed object(s) in motion). One embodiment can provide for bandwidth and computational requirements reduced to near 25% of conventional methods with comparable final accuracy of motion tracking. The following detailed description together with the accompanying drawings will provide a better understanding of the nature and advantages of the present invention.

### BRIEF DESCRIPTION OF THE DRAWINGS

FIG. 1 illustrates a system for capturing image data according to an embodiment of the present invention.

FIG. 2 depicts multiple types of filters applied to the sensor pixels according to an embodiment of the present invention.

FIGS. 3A-3E illustrate light centered at various dominant wavelengths passing the multiple type of filters according to various embodiments of the present invention.

FIGS. 4A-4D depict multiple types of filters applied to the sensor pixels according to various embodiments of the present invention.

FIG. 5 depicts an image sensor having various types of light-sensing pixels according to an embodiment of the present invention.

FIG. 6 depicts a system utilizing multiple types of filters in combination with an image sensor having various types of light-sensing pixels according to an embodiment of the present invention.

FIG. 7A illustrates utilizing different or different numbers of light sources for varying lighting conditions according to various embodiments of the present invention.

FIG. 7B illustrates a characteristic dynamic range of an electronic image sensor according to an embodiment of the present invention.

FIG. 7C illustrates exposure intervals that may be utilized according to an embodiment of the present invention.

FIG. 7D illustrates various sensor setting that may be utilized according to an embodiment of the present invention.

FIG. 8 is a simplified block diagram of a computer system implementing an image analysis apparatus according to an embodiment of the present invention.

FIGS. 9A-9C are graphs of brightness data for rows of pixels that may be obtained according to an embodiment of the present invention.

FIG. 10 is a flow diagram of a process for identifying the location of an object in an image according to an embodiment of the present invention.

FIG. 11 illustrates a timeline in which light sources pulsed on at regular intervals according to an embodiment of the present invention.

FIG. 12 illustrates a timeline for pulsing light sources and capturing images according to an embodiment of the present invention.

FIG. 13 is a flow diagram of a process for identifying object edges using successive images according to an embodiment of the present invention.

FIG. 14 is a top view of a computer system incorporating a motion detector as a user input device according to an embodiment of the present invention.

FIG. 15 is a front view of a tablet computer illustrating another example of a computer system incorporating a motion detector according to an embodiment of the present invention.

FIG. 16 illustrates a goggle system incorporating a motion detector according to an embodiment of the present invention.

FIG. 17 is a flow diagram of a process for using motion information as user input to control a computer system or other system according to an embodiment of the present invention.

FIG. 18 illustrates a system for capturing image data according to another embodiment of the present invention.

FIG. 19 illustrates a system for capturing image data according to still another embodiment of the present invention.

### DETAILED DESCRIPTION

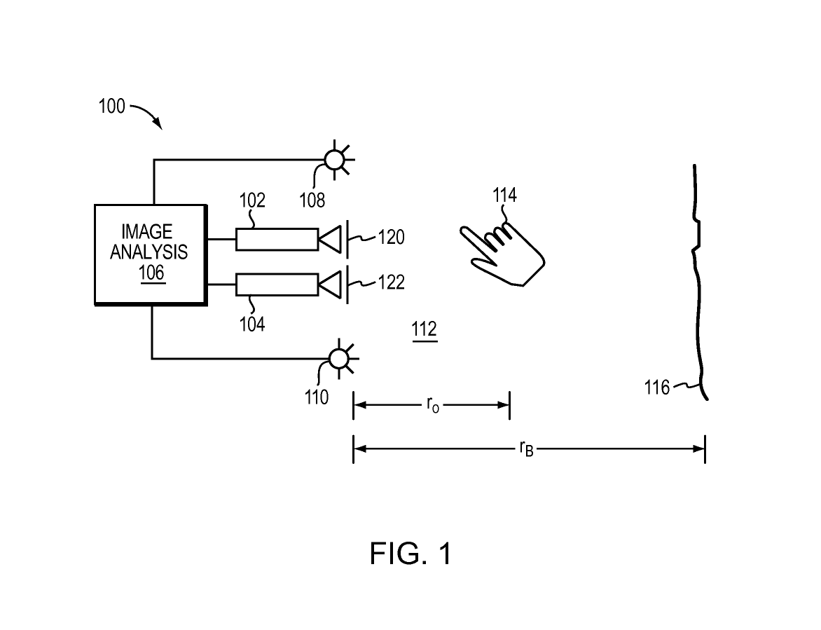

Refer first to FIG. 1, which illustrates a system 100 for capturing image data according to an embodiment of the present invention. System 100 includes a pair of cameras 102, 104 that can be integrally, and/or non-integrally coupled to an image-analysis system 106. Cameras 102, 104 can be any type of camera, including cameras sensitive across the visible spectrum or, more typically, with enhanced sensitivity to a confined wavelength band (e.g., the infrared (IR) or ultraviolet bands); more generally, the term “camera” herein refers to any device (or combination of devices) capable of capturing an image of an object and representing that image in the form of digital data. For example, line sensors or line cameras rather than conventional devices that capture a two-dimensional (2D) image can be employed. Of course a camera is not required, and other mechanisms for imaging mechanisms, e.g., scanners, photo-sensitive arrays or arrangements, and/or other types of image sensors, can serve to capture images in various embodiments. The term “light” is used generally to connote any electromagnetic radiation, which may or may not be within the visible spectrum, and may be broadband (e.g., white light) or narrowband (e.g., a single wavelength or narrow band of wavelengths).

The heart of a digital camera is an image sensor, typically comprising a plurality of light-sensitive picture elements (pixels), which can have a co-planar arrangement into a pixel array, or can have a non-coplanar arrangement, or can be a linear 2D arrangement, such as in the case of a line sensor. A lens focuses light onto the surface of the image sensor, and the image is formed as the light strikes the pixels with varying intensity. Each pixel converts the light into an electric charge whose magnitude reflects the intensity of the detected light, and collects that charge so it can be measured. Both CCD and CMOS image sensors perform this same function but differ in how the signal is measured and transferred.

In a CCD sensor, the charge from each pixel is transported to a single structure that converts the charge into a measurable voltage. This is done by sequentially shifting the charge in each pixel to its neighbor, row by row and then column by column in “bucket brigade” fashion, until it reaches the measurement structure. A CMOS sensor, by contrast, places a measurement structure at each pixel location. The measurements are transferred directly from each location to the output of the sensor.

Some image sensors have small lenses manufactured directly above the pixels to focus the light on the active portion of the pixel array. In general, image-sensor pixels are sensitive to light intensity and not as sensitive to wavelength, i.e., color. Unaided, the pixels will capture any kind of light and create a binary (e.g., black-and-white) image. In order to distinguish between colors, filters are applied to the pixels, or to sets of pixels and/or subsets thereof to control the response of the pixels to incoming light. Since all colors can be broken down into a color gamut (e.g., an RGB or CMYK pattern), individual primary or complementary color schemes are deployed on the pixel array. Software reconstructs the original scene based on pixel light intensities and knowledge of which color overlies each pixel. Any of a variety of different filters can be used for this purpose, the most popular being the Bayer filter pattern (also known as RGBG).

Cameras 102, 104 are preferably capable of capturing video images (i.e., successive image frames at a constant rate of at least 15 frames per second), although no particular frame rate is required. The capabilities of cameras 102, 104 are not critical to the invention, and the cameras can vary as to frame rate, image resolution (e.g., pixels per image), color or intensity resolution (e.g., number of bits of intensity data per pixel), focal length of lenses, depth of field, etc. In general, for a particular application, any cameras capable of focusing on objects within a spatial volume of interest can be used. For instance, to capture motion of the hand of an otherwise stationary person, the volume of interest might be defined as a cube approximately one meter on a side.

System 100 also includes a pair of light sources 108, 110, which can be disposed to either side of cameras 102, 104, and controlled by image-analysis system 106. Light sources 108, 110 can be infrared light sources of generally conventional design, e.g., infrared light-emitting diodes (LEDs), and cameras 102, 104 can be sensitive to infrared light. Filters 120, 122 can be placed in front of cameras 102, 104 to filter out visible light so that only infrared light is registered in the images captured by cameras 102, 104. In some embodiments where the object of interest is a person's hand or body, use of infrared light can allow the motion-capture system to operate under a broad range of lighting conditions and can avoid various inconveniences or distractions that may be associated with directing visible light into the region where the person is moving. Of course, particular wavelength(s) or region(s) of the electromagnetic spectrum are not required.

According to one aspect, some embodiments utilize filters associated directly with the image sensor of a camera. That is, the filters and/or filtering can be selectively applied to specific pixels (e.g., pixel rows, columns, mixed axis patterns (e.g., an RGB, CMYK, or RGBG pattern), (pseudo-)random, fractions (e.g., left half, bottom quarter, right third, etc.) of an array of pixels, or the like and/or combinations thereof) of the sensor using a variety of techniques (e.g., physical filters can be positioned to intervene between the active portions of the pixels and incoming light; hardware filters can be implemented using multiple types of pixels exhibiting differing optical characteristics, single or multiple types of pixels made (dynamically) tunable to set particular optical characteristics; software filters can be algorithmically and/or selectively applied to data derived from the outputs of pixels; mixed hardware/software filters can selectively “activate” subsets (or all) of the pixels to control the pixel's sensitivity, (i.e., “sensitize”), to characteristics of light, thereby causing the activated pixels to output data in conformance with the instructions provided by the software—i.e., respond only if triggered (e.g., detecting a presence and/or detecting a quantity over a certain threshold and/or range in any or combinations of frequency, polarization, intensity, etc.)

Accordingly, these filters may implement a Bayer filter as described above, and can be used in conjunction with or without micro-lenses associated with sensor.

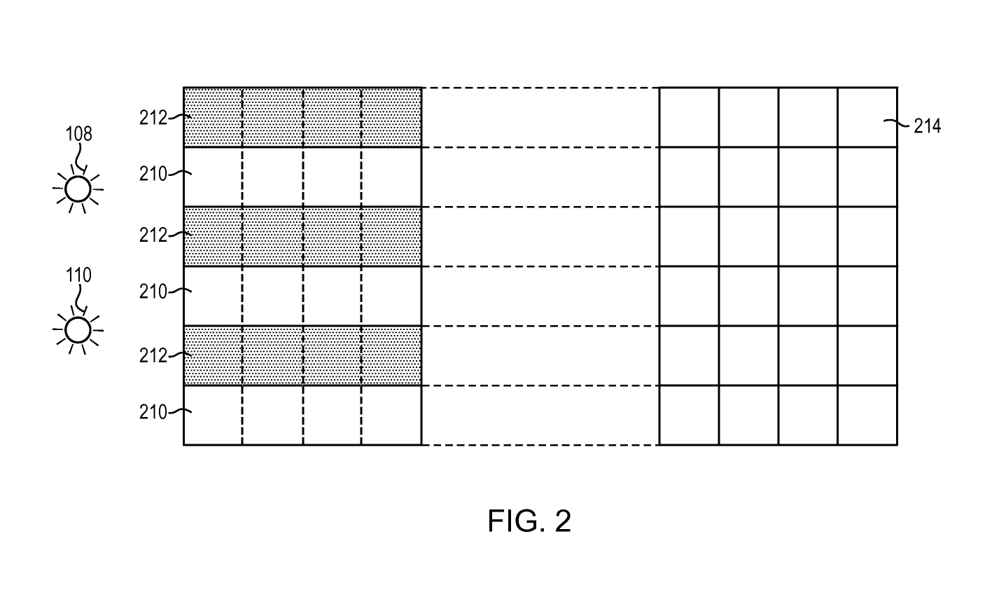

Referring to FIG. 2, in one embodiment, two or more types of filters 210, 212 are applied to the sensor pixels 214 in, for example, row-interlaced form. A first filter type 210 (e.g., covering even pixel rows) allows transmission of wavelengths associated with the light sources 108, 110. A second filter type 212 (e.g., covering odd pixel rows) does not allow the transmission of wavelengths associated with the light sources 108, 110. Image-analysis system 106 compares the images captured by the differently filtered sets of pixels, then uses the image corresponding to pixels to which the second filter type 212 was applied to remove noise from the image corresponding to pixels to which the first filter type 210 was applied. This may be accomplished, for example, using the ratio between the two images (i.e., taking the pixel-by-pixel amplitude ratios and eliminating, from the first image, pixels whose ratio falls below a threshold). The use of multiple filters 210, 212 more reliably excludes “noise” wavelengths than would a single filter applied over the entire image. For example, in a system in which light sources 108, 110 have a dominant emission wavelength of 850 nm, all even rows of pixels may have a band-pass filter that passes 850 nm light and all odd rows of pixels may have a notch or band-stop filter that removes 850 nm light.

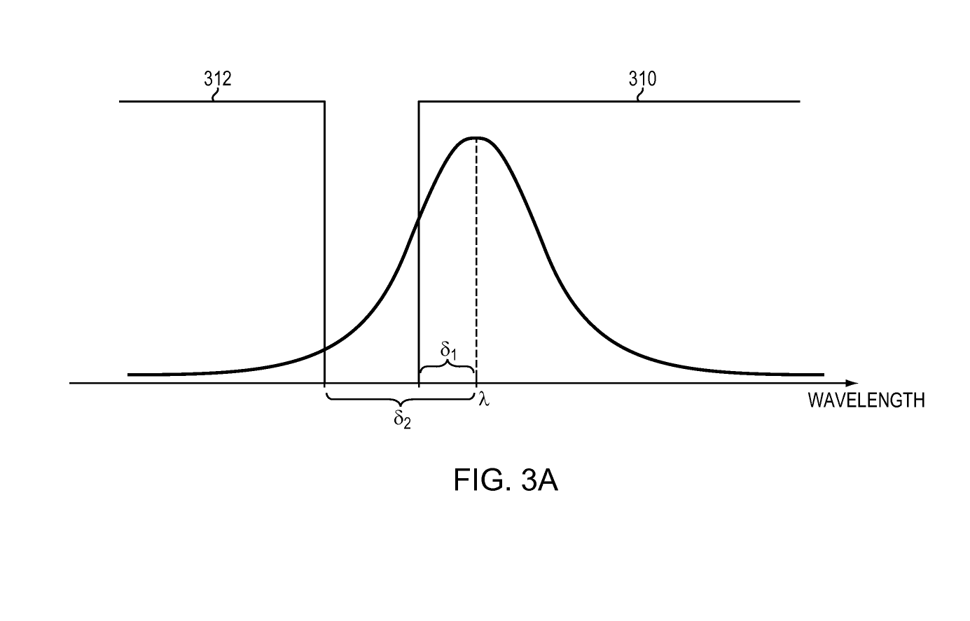

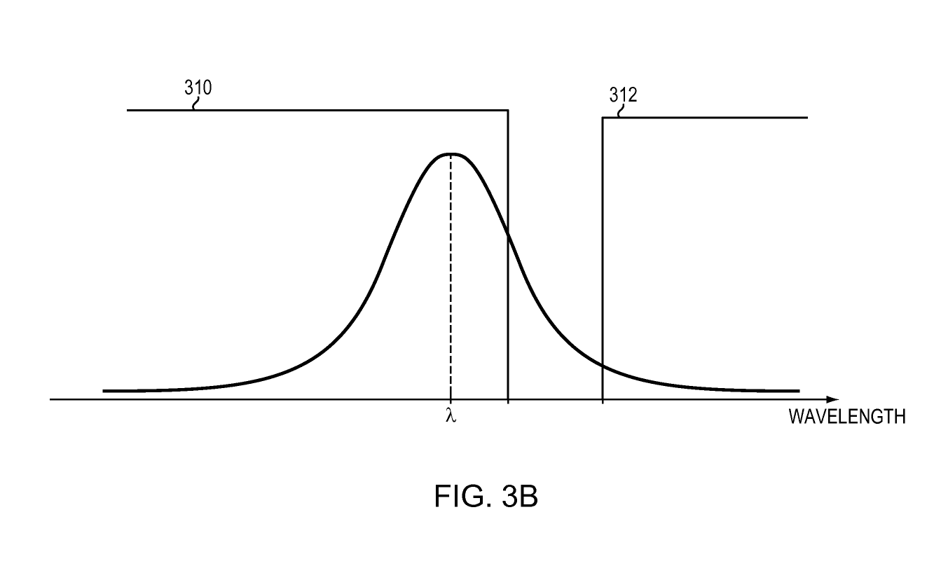

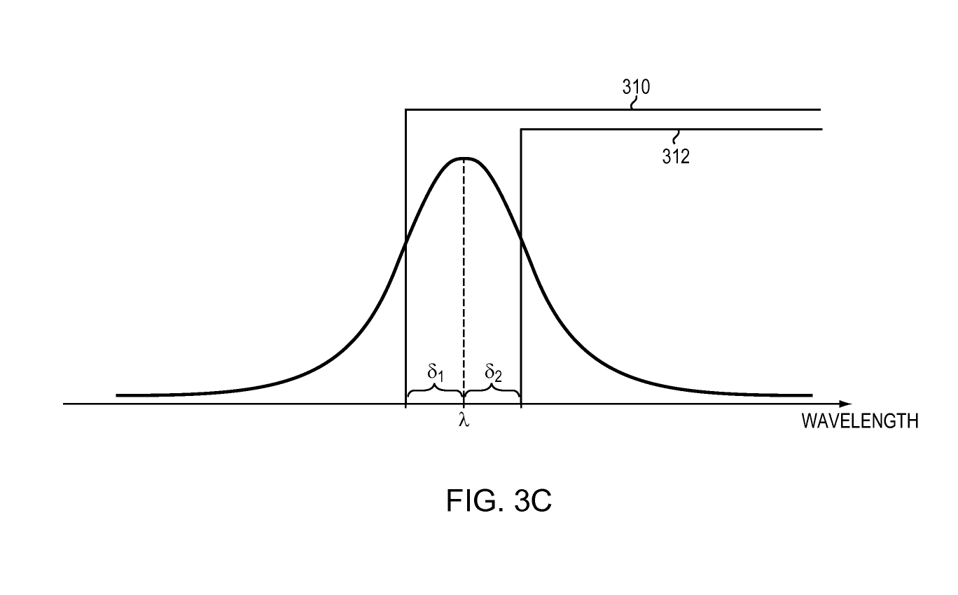

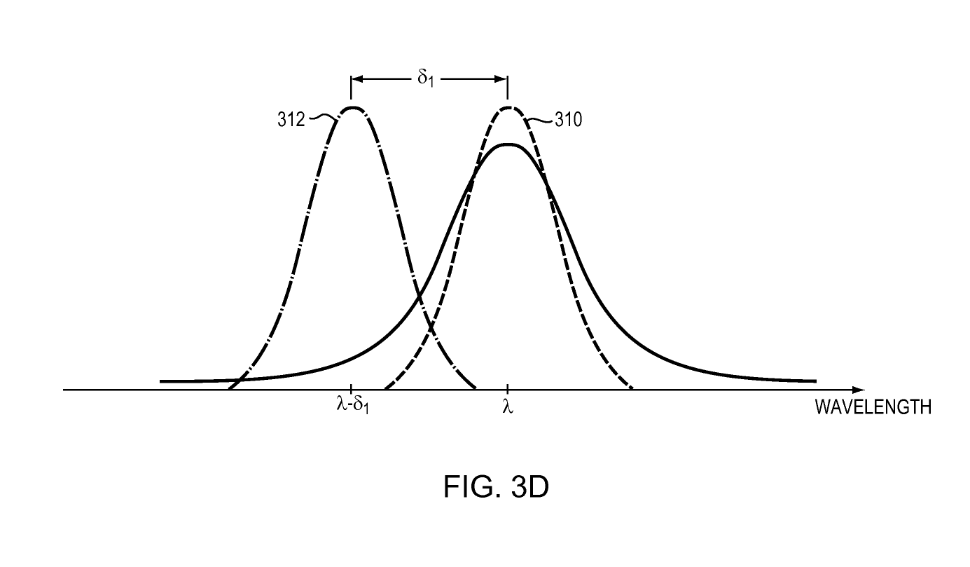

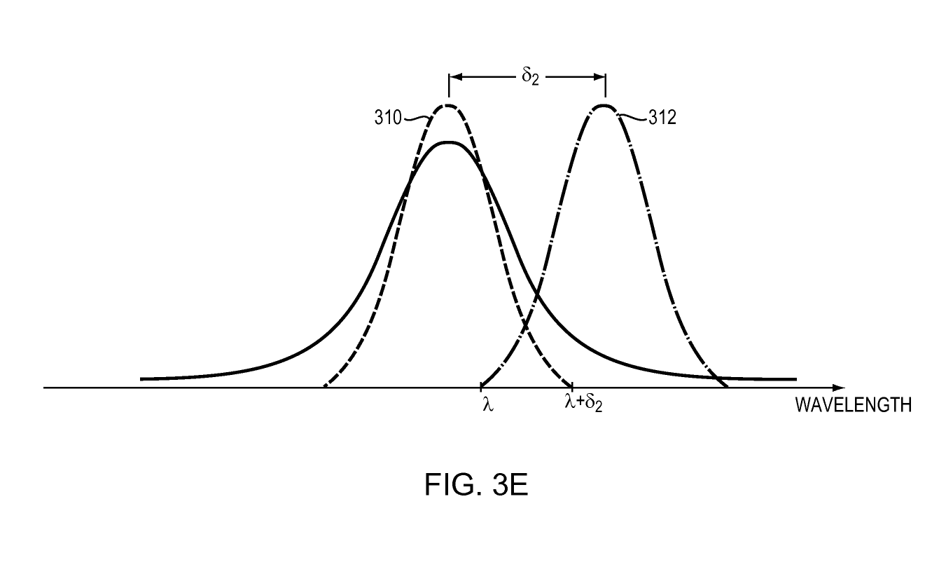

Various embodiments that advantageously employ this technique are possible and within the scope of the invention. Referring to FIG. 3A, for example, suppose that the source illumination contains a narrow band of wavelengths centered about a dominant emission wavelength λ. The first type of filter 310 may substantially pass only wavelengths greater (i.e., longer) than a threshold wavelength, which is itself typically slightly shorter than λ, (i.e., the threshold wavelength is λ−δ₁, where, for example, δ=850 nm and δ₁=50, so that the first type of filter substantially passes all wavelengths above 800 nm), while the second type of filter 312 substantially passes only wavelengths more than a threshold amount below (i.e., shorter than) the dominant source wavelength λ, (i.e., the second type of filter passes only wavelengths below λ−δ₂, where, for example, δ₂=200, so only wavelengths below 600 nm are passed). Typically, δ₂>δ₁. Alternatively, referring to FIG. 3B, the first type of filter 310 may substantially pass only wavelengths shorter than a threshold wavelength, which is itself typically slightly longer than λ, while the second filter 312 substantially passes only wavelengths more than a threshold amount above (i.e., longer than) the source wavelength λ.

Referring to FIG. 3C, in still another alternative, the second type of filter 312 may substantially pass wavelengths more than a threshold amount above λ; whereas the first type of filter 310 substantially passes wavelengths above λ−δ₁, as before, the second type of filter 312 passes wavelengths above λ+δ₂. Typically, the second-filter threshold equals or exceeds the first-filter threshold λ, i.e., δ₂>δ₁. In one implementation, λ=850 nm and δ₁=δ₂=50, so that the first type of filter passes substantially all wavelengths above 800 nm (but substantially none below), while the second type of filter passes substantially all wavelengths above 900 nm (but substantially none below). High-pass and low-pass filters are inexpensive and easily made, but they are not necessary to the operation of the invention. Moreover, it is not necessary to have a sharp cut-off frequency. For example, referring to FIGS. 3D and 3E, in some embodiments, the first filter type 310 is a normal color filter that passes wavelengths centered around (but with increasing attenuation above and below) λ. The second filter type 312 passes light wavelengths centered around a wavelength different from λ, i.e., centered around λ−S₁ or λ, +δ₂. Although small values of δ₁ or δ₂ result in overlapping wavelengths due to the gradual rather than abrupt filter cut-off, the ability to discriminate is preserved using amplitude ratios, i.e., exploiting the fact that overlapping wavelengths will have at least somewhat attenuated amplitudes due to the filter characteristic (i.e., the roll-off from the center wavelength). In general, the filter wavelength is at least 50 nm above or below the dominant wavelength. One exemplary implementation for λ==850 nm utilizes, for the first type of filter 310, a normal color filter that substantially passes wavelengths centered around (but with increasing attenuation above and below) 850 nm, while the second type of filter 312 is a blue color (band-pass) filter that substantially passes wavelengths around 450 nm but not light near 850 nm (i.e., δ₁=400) (FIG. 3D). Alternatively, the second type of filter 312 may be a band-pass filter that substantially passes wavelengths closer to λ, e.g., around 900 nm (so that δ₂=50) (FIG. 3E), in which case image-analysis system 106 utilizes light ratios and/or positions to eliminate the effect of overlapping wavelengths.

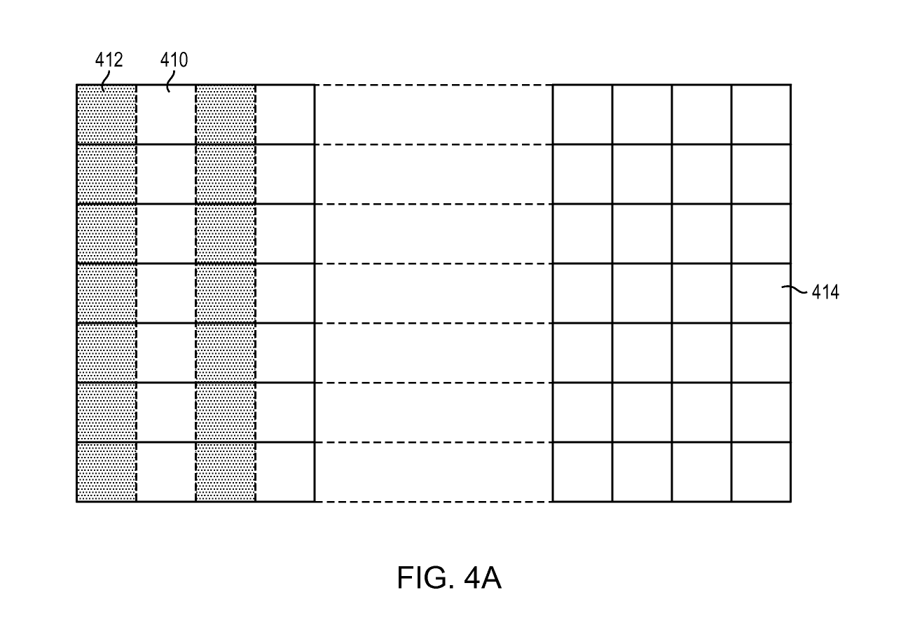

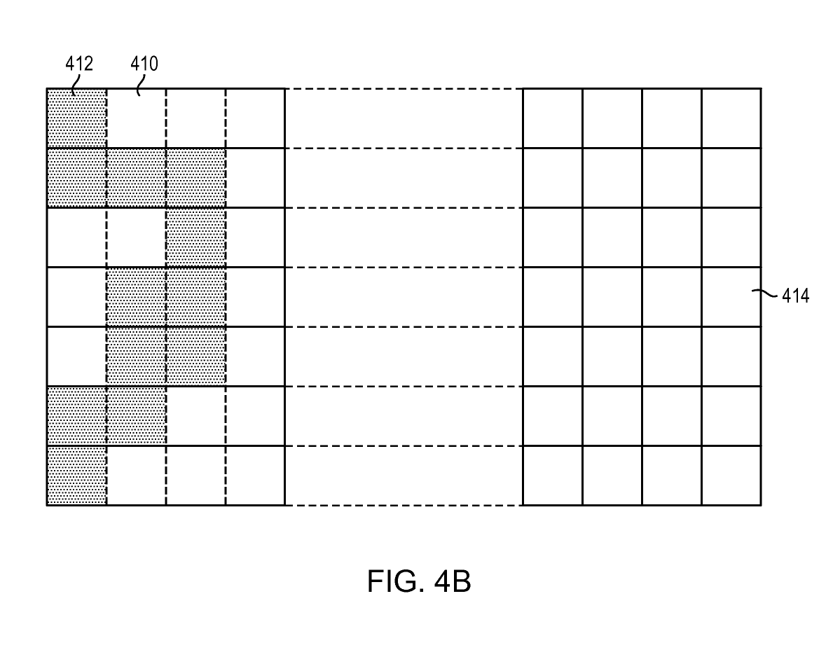

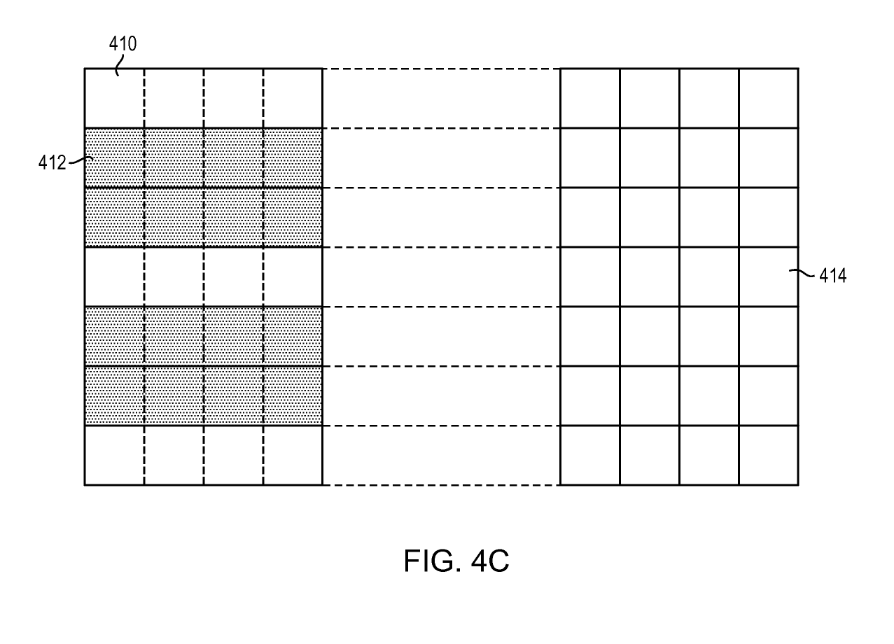

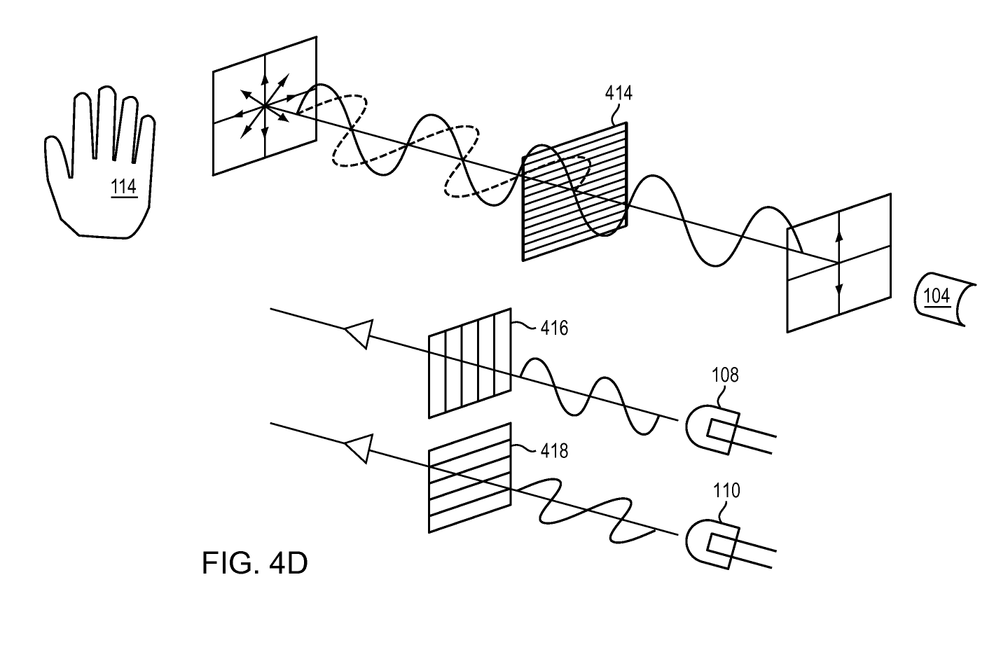

FIGS. 4A and 4B show that filters 410, 412 need not be applied row-wise, but instead can be applied column-wise and/or conform to any mixed-axis pattern suitable to a particular application. Likewise, referring to FIG. 4C, filters 410, 412 need not be unitary in nature, but can be individual to individual pixels, or group(s) of pixels, and may be used in conjunction with micro-lenses and/or other optical elements. It may also be advantageous, depending on the application, to have the different filters be applied to different relative numbers of pixels—in effect creating two images of different resolution. It is found, for example, that a lower-resolution image, where each pixel is the average value between a 2×2 pixel block in the larger image, but with a larger-than-normal bit-depth (e.g., 10-bit instead of the conventional 8-bit), the final accuracy of motion tracking is almost completely unaffected; but because of the near 50% decrease in resolution across each axis, bandwidth and computational requirements are reduced to near 25% of the original levels. Embodiments can achieve such advantage using one or more of various known brightness-based center-of-mass or edge-detection-based image-processing algorithm(s).

Polarizing the light either on emission or reception can be employed advantageously in some embodiments. For example, it may lower the processing load of a receptor in embodiments that accept light after it has been filtered for wavelength and/or polarization. In an embodiment and with reference to FIG. 4D, filter 414 can be a polarizing filter, chosen to selectively pass radiant energy having a particular polarization, while blocking radiation of different polarization. In one embodiment, filter 414 acts to reduce extraneous signal noise in the form of energy reflecting off surfaces not associated with the object of interest 114 by eliminating these reflections based on differences in polarization. Accordingly, filter 414 can be selected to work in conjunction with the light sources 108, 100 for example, so that sensor 104 receives radiant energy reflected from object of interest 114 predominantly, while reflections from other objects, having different polarizations, are blocked by filter 414. In another embodiment, polarization can be used to ensure that two sources 108, 110, do not interfere with each other in configurations in which these sources emit radiant energy at the same or similar wavelengths. For example, the light sources 108, 110 may emit light having the same or different polarizations; filters 416, 418 applied to portions of the sensor pixels may be arranged to pass different polarizations of light emitted therefrom. Image-analysis system 106 may then compare the (sub-)images captured by the differently filtered sets of pixels and use the image corresponding to pixels to which the filter 416 was applied to remove noise from the image corresponding to pixels to which the filter 418 was applied.

Another embodiment utilizes multiple light sources each emitting at a different wavelength (i.e., emitting a narrow band of wavelengths centered about a wavelength λ). Two wavelengths are employed to illustrate an example configuration for clarity sake, although any number of wavelengths can be used. Illumination at each wavelength is provided by one or more light sources 108, 110. The light sources 108, 110 are spaced apart by a known distance and have a known position relative to the cameras 102, 104. The first and second filters have filter functions tuned (or tunable or dynamically tunable) to the emitted wavelengths; for example, the filters may be narrowband filters that pass only one of the emitted wavelengths, or, as described above, they may be low-pass or high-pass filters with cutoff frequencies corresponding to, and/or displaced from, the emitted wavelengths.

With the two different filters applied to particular pixels (e.g., in an “interlaced” fashion with each filter type applied to alternating rows or columns), each set of pixels follows the light cast by a specific light source (or group of light sources emitting at e.g., a common wavelength). Knowing the position of each light source 108, 110, motion can be determined by comparing variations in sensed light intensities for each channel over time; that is, the images recorded by the differently filtered pixel sets have different angular information embedded therein. The apparent edges will move around, providing richer information from which to deduce motion (e.g., in one embodiment, this can take the form of additional tangents for ellipse-based 3D reconstruction as described in the '485 and '554 applications mentioned above; however, embodiments can employ other mechanisms for determining motion, and/or physical characteristics, and/or distance based characteristics of an object of interest in conjunction with, and/or instead of, the approaches of the '485 and/or '554 applications).

In one embodiment, an overall scene illuminated by ambient, for example, light may be preserved or reconstructed for presentation purposes. This may be accomplished, for example, using a high-pass or low-pass filter having a cut-off wavelength below or above the visible spectrum; the pixels receiving light through this filter will record the visible scene. In another embodiment, an RGB-IR filter type can be applied to the image sensor; thus the IR channel can be used for motion sensing and the RGB channel for normal imaging.

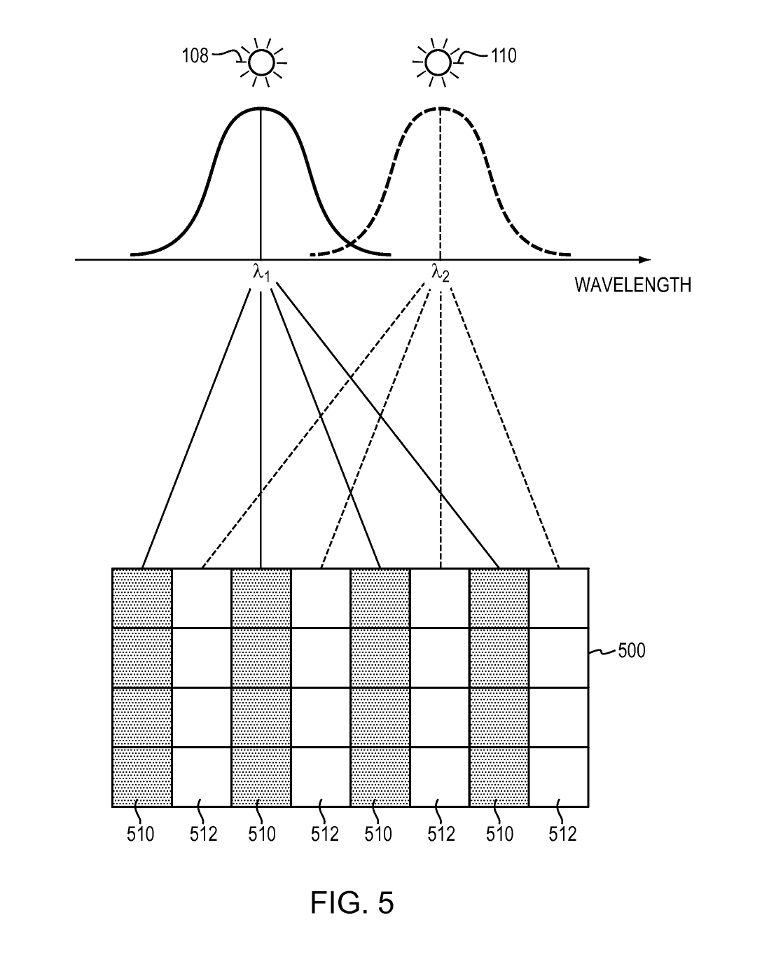

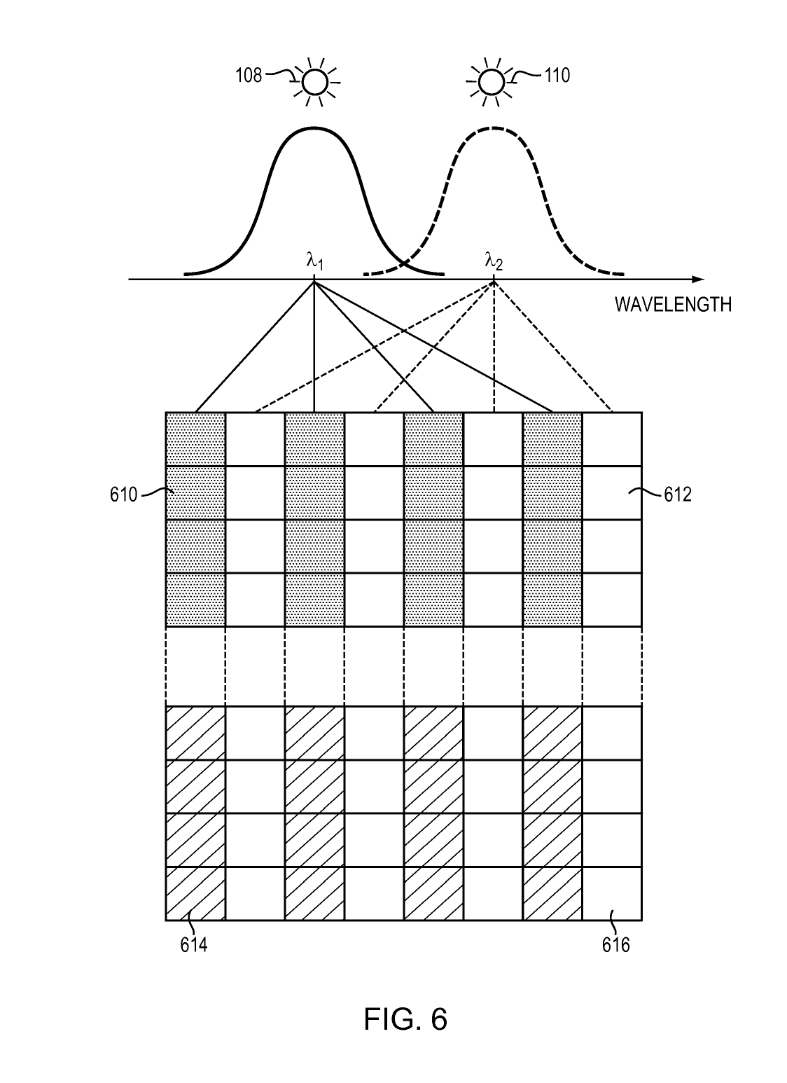

In various embodiments, the use of filters may include using an image sensor having various types of light-sensing pixels, or a single type of light sensing pixels tunable to be sensitive to a different dominant emission property (e.g., frequency, wavelength, polarization, and/or combinations thereof) of light. Such embodiments can provide a plurality of information subsets (or sub-images) in each image. Referring to FIG. 5, for example, an image sensor 500 has first and second pixel types 510, 512, which are employed to detect light centered around wavelengths λ₁ and λ₂, respectively. Wavelength is used in this example, however embodiments will employ analogous techniques using any optical characteristic or property of electromagnetic radiation. Illumination at each wavelength of λ₁ and λ₂ may be provided by, for example, the light sources 108, 110, respectively. It should be noted that although FIG. 5 depicts two column-interlaced pixel types 510, 512, the pixel types 510, 512 need not be arranged in a column-wise or row-wise fashion but instead can conform to any mixed-axis pattern suitable to a particular application. In operation, images in the field of view of the cameras 102, 104 are formed as light reflected and/or scattered from the object of interest 114 strikes the image sensor 500 thereof with varying intensity. Because the first pixel type 510 can be made sensitive to wavelengths centered around λ₁, light emitted from the light source 108 and/or reflected or scattered from the object 114 may be detected by the first pixel type 510 and converted into an electric signal to form an image; whereas light emitted from the light source 110, having a center wavelength λ₂, is not detectable (e.g., it has a signal-to-noise ratio (SNR) much less than unity) by the first pixel type 510, thereby failing to form images thereon. Pixels can be made sensitive to (or sensitized to) optical characteristics or properties of electromagnetic radiation using various techniques (e.g., fabricated in custom arrangements of pixels in the sensor; sensors having tunable sensitivity to one or more optical properties at the row, column and/or pixel level by application of signal controlled by hardware, software, firmware and/or combinations thereof (“commanded sensitivity”); application of techniques in software to discern information in a plurality of channels from an image, and/or combinations thereof). Likewise, light emitted from the light source 110 activates the second pixel type 512 and forms images thereon, while light emitted from light source 108 is not detected. As a result, when light sources 108, 110 illuminate the field of view, the captured image includes two sub-images, each associated with one pixel type or commanded sensitivity. As described above, the image-analysis system 106 can then compare the sub-images captured by the different sets of pixel types 510, 512, remove noise from each sub-image, and generate high-quality images. Additionally, any number of sub-images may be combined according to any arithmetic or image processing algorithm to remove noise therefrom. In some embodiments, the approach of utilizing an image sensor having various types of light-sensing pixels is combined with the approach of using different types of filters to further remove image noise. Referring to FIG. 6, for example, two or more filter types 610, 612 may be applied to two or more types of sensor pixels 614, 616. The first and second filters 610, 612 have filter functions tuned (or tunable) to the emitted wavelengths λ₁ and λ₂ of the light sources 108, 110, respectively; for example, the filters may be narrowband filters that pass only one of the emitted wavelengths, or, as described above, they may be low-pass or high-pass filters with cutoff frequencies corresponding to, or displaced from, the emitted wavelengths. Wavelength is used in this example, however embodiments will employ analogous techniques using any optical characteristic or property of electromagnetic radiation. In one embodiment, the first filter type 610 selectively transmits light wavelengths centered around λ₁; the transmitted light is then projected onto the first-type sensor pixels 614. Similarly, light centered around the wavelength λ₂ is selectively passed through the second filter type 612 and projected onto the second type of sensor pixels 616. As described above, λ₁ and λ₂ may satisfy equations λ₁=λ±δ₁ and λ₂=λ±δ₂, wherein δ₂>δ₁. In general, δ₂ and δ₁ are small values (e.g., 100 nm) compared to λ (e.g., 800 nm). In one implementation, λ₁ and λ₂ are far apart in the spectrum such that the first and second types of filters 610, 612 are substantially opaque to the wavelengths λ₂ and λ₁, respectively. Note that although the two filter types 610, 612 and two pixel types 614, 616 in FIG. 6 are arranged in a column-wise interlaced fashion (i.e., in alternating pixel columns), a row-wise interlaced fashion or any mixed-axis pattern that is suitable to a particular application may also be used. Again, each filter type can cover a different numbers of sensor pixels (e.g. a first type of filter may be 1×2 pixels or 2×3 pixels in size). In one embodiment, the image-analysis system 106 removes noise from the images by comparing the pixel-by-pixel amplitude ratios between two images (or sub-images) captured by the different sets of sensor pixels 614, 616, separately. Because the use of multiple filters 610, 612 can reliably exclude noise at wavelengths that otherwise would have been detected by the sensor pixels 614, 616, the approach of combining multiple types of filters and multiple types of sensor pixels enables some embodiments to provide significantly improved image quality. The light sources 108, 110 may be disposed outside the field of view of the cameras 102, 104. Additionally, the light sources 108, 110 may be spaced apart by a known distance and have a known position relative to the cameras 102, 104. In some embodiments, the light sources 108, 110 may be positioned laterally with respect to the cameras 102, 104. Because images recorded by the different sets of sensor pixels can contain different angular information about the object of interest 114 embedded therein, knowing the position of each light source 108, 110 and the relative positions thereof with respect to the cameras 102, 104 provides sufficient parameters for the image-analysis system 106 to determine the shape and position of the object of interest 114. In addition, the motion of the object in three-dimensional (3D) space can be reconstructed according to a temporal collection of the captured images in a time-sequenced series as described in the '485 and '554 applications mentioned above.

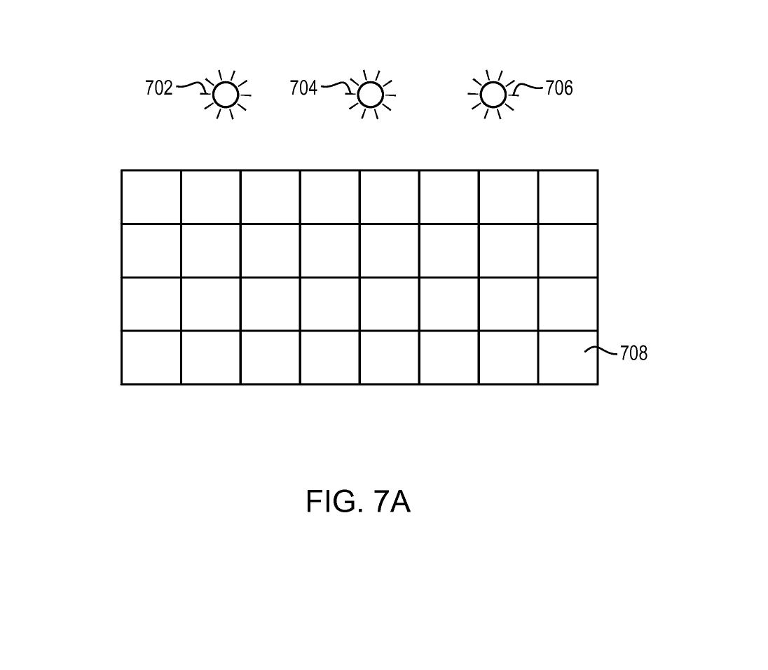

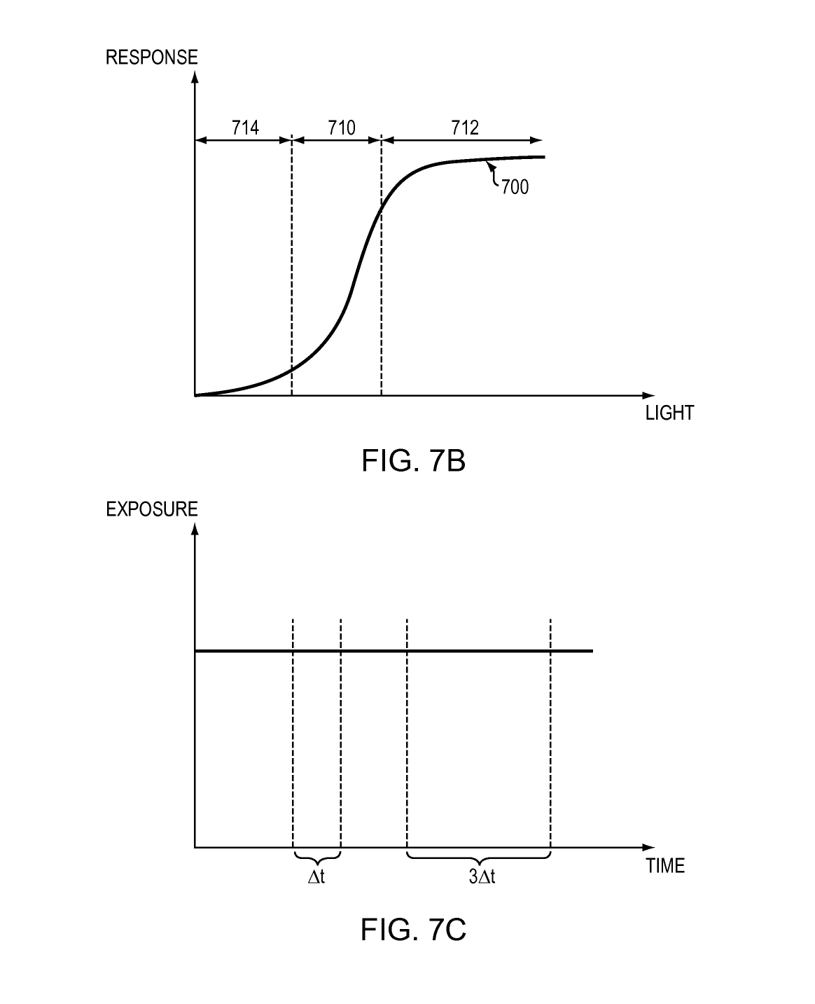

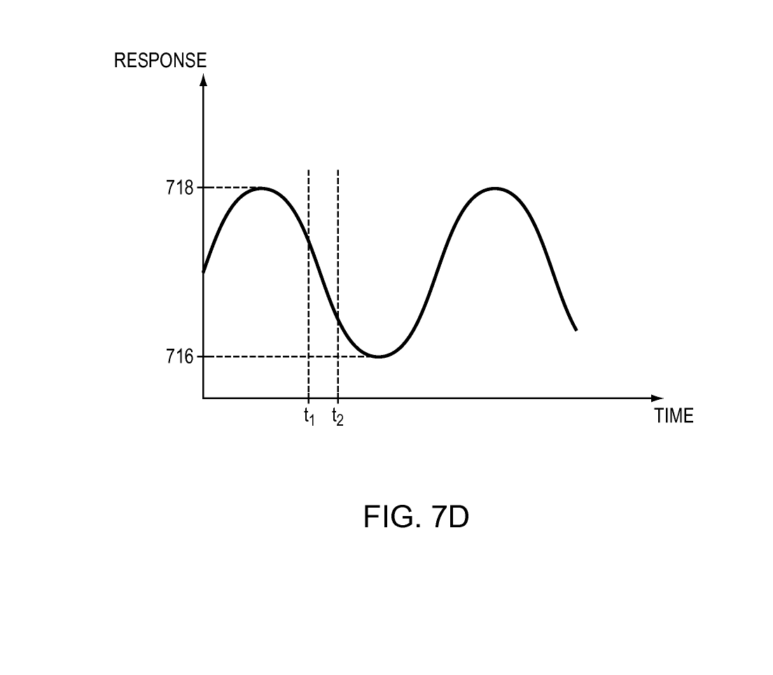

In still another approach, the use of multiple types of filters and/or multiple types of image-sensing pixels can include the use of multiple successive light exposures from different, or different numbers of, light sources—for example, to provide time-varying lighting conditions within the field of view of the cameras. Referring to FIG. 7A, various images may be acquired under different lighting conditions (e.g., varying intensity of the light sources) by using different light sources 702, 704, 706, each uniformly emitting a different amount (e.g., intensity or brightness) of light to object(s) in the field of view of the cameras, and/or different combinations of the light sources 702, 704, 706. For example, the image sensor 708 may capture an image illuminated by the dimmest light source 702 at a time t₁ and successively capture images illuminated by the light sources 704, 706, both brighter than source 702, at times t₂ and t₃, respectively; the successively brighter images will generally have correspondingly higher contrast. The successive images are acquired so rapidly that, in a motion-capture context, little or no object movement will have occurred between the images. In addition, the intensity of light sources 704, 706 may be dynamically adjusted after each capture of the images at time t₁ and t₂ in order to improve the contrast difference. In another embodiment, the light sources 702, 704, 706 emit light at different wavelengths. Alternatively, the light sources 702, 704, 706 may be identical; the image sensor 708 first captures an image illuminated only by the light source 702 at the time t₁ and subsequently captures another image while the object is illuminated by a combination of the light sources 704, 706 at the time t₂. In some embodiments, exposures of the image sensor 708 are synchronized with the different light sources, light source combinations, and/or light source adjustments.

In some embodiments, the images having various exposures are then compared to remove noise from a “base” image captured at an exposure level matched to, for example, the average luminance of the scene. Noise removal may be accomplished by, for example, subtracting a higher-contrast image from the base image. In effect, noise removal using this approach is accomplished by time multiplexing of the images rather than wavelength multiplexing of the light sources.

In various embodiments, opening and closing the shutter at different times results in images having various exposure levels. This approach may be understood with reference to the response characteristics of image sensors 708. Referring to FIG. 7B, every photographic medium, including an electronic image sensor 708, exhibits a characteristic response curve 700 and an associated dynamic range 710—that is, the region of the response curve 700 in which tonal variations of the scene result in distinguishable pixel responses. The “speed” of a photographic film, for example, reflects the onset of the useful recording range 710. Above this range, the image will be “saturated” (i.e., in a saturated regime 712) as the sensor 708 becomes incapable of responding linearly (or log-linearly) to differently illuminated features; and below this range (i.e., in an inactive regime 714), shadow detail may lack sufficient luminance to produce a sensor response at all, i.e., it will not be recorded and the overall scene will have very low contrast. The width and location (relative to light intensity) of the useful recording region 710 may depend upon the well depth of the individual pixels, which limits the number of photon-produced electrons that are collected. Referring to FIGS. 7B and 7C, in some embodiments, the range 710 determines the exposure times of the cameras 102, 104. For example, the exposure times may be adjusted such that pixel values of the sensor 708 are or are not within the range 710. The different exposure times are achieved by opening the shutters of cameras 102, 104 (thereby exposing the sensor 708) for different time intervals. For example, the first image may be acquired with an exposure time interval of Δt and the second image may be acquired with an exposure time interval of 3Δt. As a result, the second image is three times as bright as the first image, and only one of the images will be have substantial scene detail within the dynamic range 710. Additionally, the camera shutters may be synchronized with the different light sources, light source combinations, and/or light source adjustments to achieve different exposure levels—and, consequently, different placement along the curve 700 in the captured images. For example, the light sources 702, 704, 706 may emit light at a constant intensity and a combination of the camera shutters and/or camera electronics are used to achieve different exposure times, and hence different exposure levels for the images captured at times t₁ and t₂. If the dimmest exposure places scene detail within the dynamic range 710, the second image will have greater saturation and, hence, greater contrast.

Alternatively, placement of scene detail along the response curve 700 can be achieved by varying the sensitivity of the pixels of the image sensor 708. With reference to FIG. 7D, the sensor's responsiveness to light may be set to vary with time (for example, cycling between the lowest value 716 and a highest value 718). By rapidly acquiring two separate images at different sensor settings at different times t₁ and t₂, normal-contrast and high-contrast images of the same scene may be obtained. Accordingly, each captured image has a range of pixel values representing a band within the boundaries of the pixel response levels (typically between 0 and 255). Occasionally, an image is captured with a different band of pixel values (e.g., all of the pixel values fall between 0 and 15); this may lead to difficulties when comparing the amplitudes between the images. To solve this problem, the images may be first manipulated using, for example, tone mapping to map one set of more limited pixel values in one image to another set of broader pixel values (e.g., between 0 and 255) in a second image. The tone-mapped images are then processed for noise removal. In one implementation, pixel values of several images captured under the same illumination conditions, same exposure times, and/or same sensor settings, are first averaged to reduce the overall noise; the averaged image may be tone-mapped to the set of pixel values in the base image such that the averaged image can serve as a comparison image to remove noise from the normal scene image through subtraction or other image-comparison operations.

More generally, one or more comparison images having a different (typically greater) contrast than a properly exposed image are generated and used to remove noise from the properly exposed image to create an improved image; this time-multiplexing technique creates comparison images that differ from the base image in terms of, for example, the number of lighting sources active during exposure, the type of lighting sources, the exposure time intervals, and/or the dynamic-range setting of the sensor. In typical implementations, a single high-contrast (or low-contrast) image is obtained in addition to the normal scene image, but various applications may benefit from a series of exposures with different levels of contrast, e.g., multiple high-contrast (or low-contrast) images with different degrees of saturation or images with contrast levels above and below the normal-contrast image.

This time-multiplexing technique may be combined with different types of filtering techniques and/or different types of image sensors as described above. For example, the image-analysis system 106 may first remove noise using wavelength multiplexing of the light passing through the multiple types of filters followed by time multiplexing of the images acquired at different times or within different time intervals; this may significantly improve the signal-to-noise ratio, thereby generating better quality images for identifying the position and shape of the object 114 as well as tracking the movement of the object 3D space.

It should be stressed that the arrangement shown in FIG. 1 is representative and not limiting. For example, lasers of various types (e.g., gas, liquid, crystal, solid state, and/or the like and/or combinations thereof), lamps of various types (e.g., incandescent, fluorescent, halogen, and/or the like and/or combinations thereof) or other light sources can be used instead of LEDs. For laser setups, additional optics (e.g., a lens or diffuser) may be employed to widen the laser beam (and make its field of view similar to that of the cameras). Useful arrangements can also include short- and wide-angle illuminators for different ranges. Light sources are typically diffuse rather than specular point sources; for example, packaged LEDs with light-spreading encapsulation are suitable.

In operation, cameras 102, 104 are oriented toward a region of interest 112 in which an object of interest 114 (in this example, a hand) and one or more background objects 116 can be present. Light sources 108, 110 are arranged to illuminate region 112. In some embodiments, one or more of the light sources 108, 110 and one or more of the cameras 102, 104 are disposed below the motion to be detected, e.g., where hand motion is to be detected, beneath the spatial region where that motion takes place. This is an optimal location because the amount of information recorded about the hand is proportional to the number of pixels it occupies in the camera images, the hand will occupy more pixels when the camera's angle with respect to the hand's “pointing direction” is as close to perpendicular as possible. Because it is uncomfortable for a user to orient his palm toward a screen, for embodiments employed in conjunction with a terminal (e.g., computer, television, machinery), the preferable orientations are either from the bottom looking up, from the top looking down (which requires a bridge) or from the screen bezel looking diagonally up or diagonally down. In scenarios looking up there is less likelihood of confusion with background objects (clutter on the user's desk, for example) and if it is directly looking up then there is little likelihood of confusion with other people out of the field of view (and also privacy is enhanced by not imaging faces). Image-analysis system 106, which can be, e.g., a computer system, can control the operation of light sources 108, 110 and cameras 102, 104 to capture images of region 112. Based on the captured images, image-analysis system 106 determines the position and/or motion of object 114.

For example, in determining the position of object 114, image-analysis system 106 can determine which pixels of various images captured by cameras 102, 104 contain portions of object 114. In some embodiments, any pixel in an image can be classified as an “object” pixel or a “background” pixel depending on whether that pixel contains a portion of object 114 or not. With the use of light sources 108, 110, classification of pixels as object or background pixels can be based at least in part upon the brightness of the pixel. For example, the distance (r_{O}) between an object of interest 114 and cameras 102, 104 is expected to be smaller than the distance (r_{B}) between background object(s) 116 and cameras 102, 104. Because the intensity of light from sources 108, 110 decreases as 1/r², object 114 will be more brightly lit than background 116, and pixels containing portions of object 114 (i.e., object pixels) will be correspondingly brighter than pixels containing portions of background 116 (i.e., background pixels). For example, if r_{B}/r_{O}=2, then object pixels will be approximately four times brighter than background pixels, assuming object 114 and background 116 are similarly reflective of the light from sources 108, 110, and further assuming that the overall illumination of region 112 (at least within the frequency band captured by cameras 102, 104) is dominated by light sources 108, 110. These assumptions generally hold for suitable choices of cameras 102, 104, light sources 108, 110, filters 120, 122, and objects commonly encountered. For example, light sources 108, 110 can be infrared LEDs capable of strongly emitting radiation in a narrow frequency band, and filters 120, 122 can be matched to the frequency band of light sources 108, 110. Thus, although a human hand or body, or a heat source or other object in the background, may emit some infrared radiation, the response of cameras 102, 104 can still be dominated by light originating from sources 108, 110 and reflected by object 114 and/or background 116.

In one embodiment, image-analysis system 106 can quickly and accurately distinguish object pixels from background pixels by applying a brightness threshold to each pixel. For example, pixel brightness in a CMOS sensor or similar device can be measured on a scale from 0.0 (dark) to 1.0 (fully saturated), with some number of gradations in between depending on the sensor design. The brightness encoded by the camera pixels scales standardly (linearly) with the luminance of the object, typically due to the deposited charge or diode voltages. In some embodiments, light sources 108, 110 are bright enough that reflected light from an object at distance r_{O} produces a brightness level of 1.0 while an object at distance r_{B}=2r_{O} produces a brightness level of 0.25. Object pixels can thus be readily distinguished from background pixels based on brightness. Further, edges of the object can also be readily detected based at least in part upon differences in brightness between adjacent pixels, allowing the position of the object within each image to be determined. Correlating object positions between images from cameras 102, 104 allows image-analysis system 106 to determine the location in 3D space of object 114, and analyzing sequences of images allows image-analysis system 106 to reconstruct 3D motion of object 114 according to techniques for reconstructing motion of an object in three-dimensional (3D) space from a temporal collection of the captured images in a time-sequenced series as described in the '485 and '554 applications incorporated by reference above .

It will be appreciated that system 100 is illustrative and that variations and modifications are possible. For example, light sources 108, 110 are shown as being disposed to either side of cameras 102, 104. This can facilitate illuminating the edges of object 114 as seen from the perspectives of both cameras; however, a particular arrangement of cameras and lights is not required. (Examples of other arrangements are described below.) As long as the object is significantly closer to the cameras than the background, enhanced contrast as described herein can be achieved.

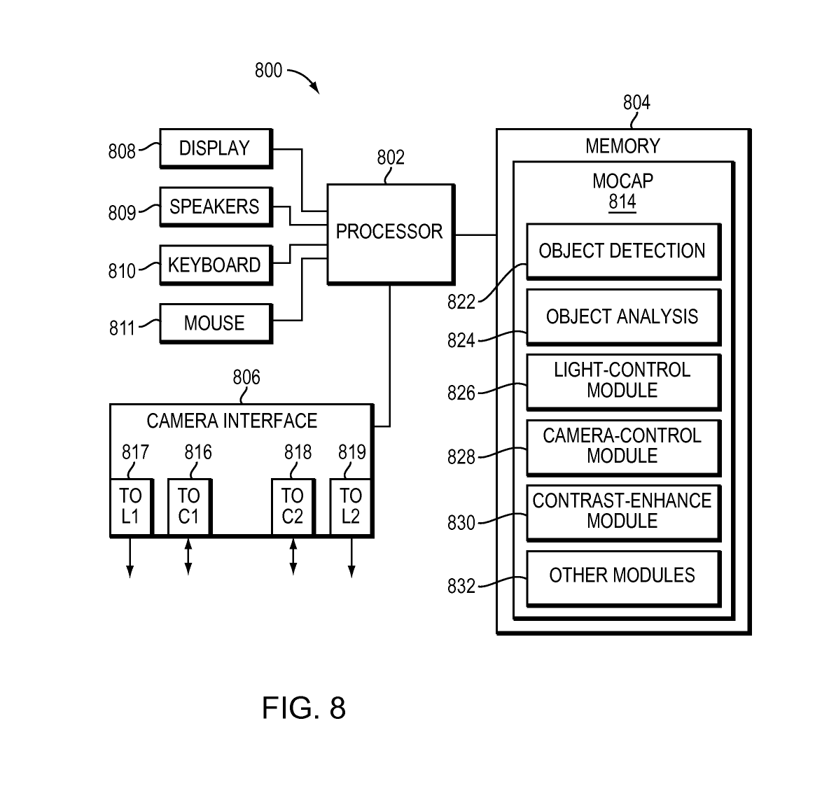

Image-analysis system 106 (also referred to as an image analyzer) can include or comprise any device or device component that is capable of capturing and processing image data, e.g., using techniques described herein with reference to embodiments. FIG. 8 is a simplified block diagram of a computer system 800, implementing image-analysis system 106 according to an embodiment of the present invention. Computer system 800 includes a plurality of integral and/or non-integral communicatively coupled components, e.g., a processor 802, a memory 804, a camera interface 806, a display 808, speakers 809, a keyboard 810, and a mouse 811.

Memory 804 can be used to store instructions to be executed by processor 802 as well as input and/or output data associated with execution of the instructions. In particular, memory 804 contains instructions, conceptually illustrated as a group of modules described in greater detail below, that control the operation of processor 802 and its interaction with the other hardware components. An operating system directs the execution of low-level, basic system functions such as memory allocation, file management and operation of mass storage devices. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system, iOS and Android mobile operating systems, or another operating system or platform.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile, transitory/non-transitory computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

Processor 802 may be a general-purpose microprocessor, but depending on implementation can alternatively be a microcontroller, peripheral integrated circuit element, a CSIC (customer-specific integrated circuit), an ASIC (application-specific integrated circuit), a logic circuit, a digital signal processor, a programmable logic device such as an FPGA (field-programmable gate array), a PLD (programmable logic device), a PLA (programmable logic array), an RFID processor, smart chip, or any other device or arrangement of devices that is capable of implementing the steps of the processes of the invention.

Camera interface 806 can include hardware and/or software that enables communication between computer system 800 and cameras such as cameras 102, 104 shown in FIG. 1, as well as associated light sources such as light sources 108, 110 of FIG. 1. Thus, for example, camera interface 806 can include one or more data ports 816, 818 to which cameras can be connected, as well as hardware and/or software signal processors to modify data signals received from the cameras (e.g., to reduce noise or reformat data) prior to providing the signals as inputs to a motion-capture (“mocap”) program 814 executing on processor 802. In some embodiments, camera interface 806 can also transmit signals to the cameras, e.g., to activate or deactivate the cameras, to control camera settings (frame rate, image quality, sensitivity, etc.), or the like. Such signals can be transmitted, e.g., in response to control signals from processor 802, which may in turn be generated in response to user input or other detected events.

Camera interface 806 can also include controllers 817, 819, to which light sources (e.g., light sources 108, 110) can be connected. In some embodiments, controllers 817, 819 supply an operating current to the light sources, e.g., in response to instructions from processor 802 executing mocap program 814. In other embodiments, the light sources can draw operating current from an external power supply (not shown), and controllers 817, 819 can generate control signals for the light sources, e.g., instructing the light sources to be turned on or off or changing the brightness. In some embodiments, a single controller can be used to control multiple light sources.

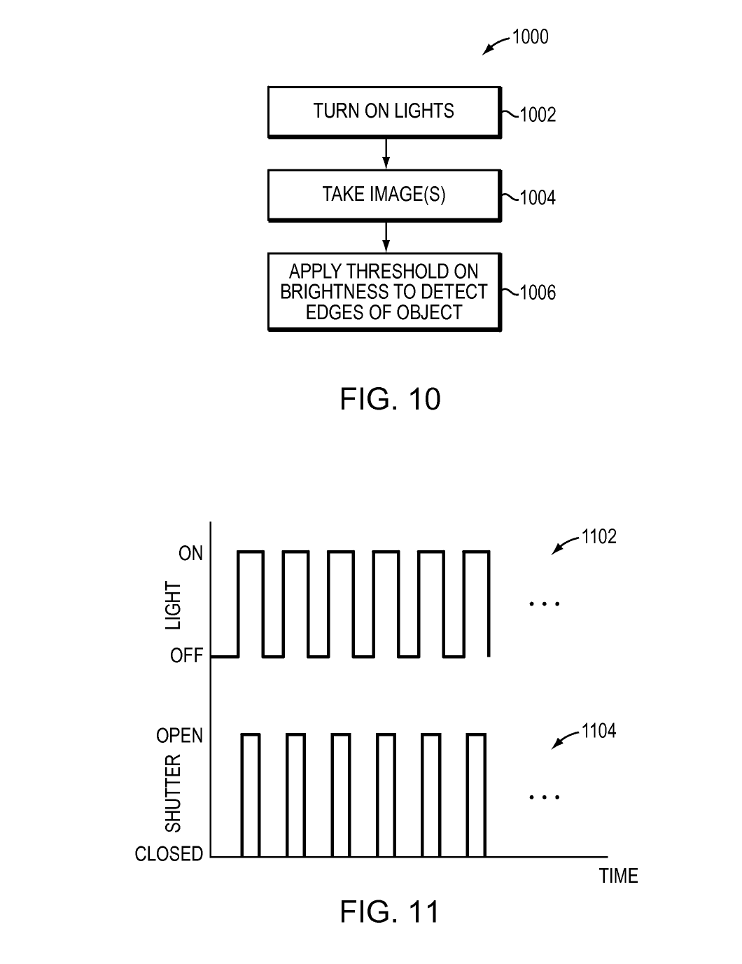

Instructions defining mocap program 814 are stored in memory 804, and these instructions, when executed, perform motion-capture analysis on images supplied from cameras connected to camera interface 806. In one embodiment, mocap program 814 includes various modules, such as an object detection module 822 and an object analysis module 824. Object detection module 822 can analyze images (e.g., images captured via camera interface 806) to detect edges of an object therein and/or other information about the object's location using techniques such as described herein with reference to FIG. 10 and/or edge detection techniques as known in the art and/or combinations thereof. Object analysis module 824 can analyze the object information provided by object detection module 822 to determine the 3D position and/or motion of the object employing techniques for reconstructing motion of an object in three-dimensional (3D) space from a temporal collection of the captured images in a time-sequenced series as described in the '485 and '554 applications mentioned above. Examples of operations that can be implemented in code modules of mocap program 814 are described herein. Memory 804 can also include other information and/or code modules used by mocap program 814. For example, the memory 804 may include a light-control module 826, which regulates the number of activated lighting sources, the type of lighting sources and/or the exposure time intervals; a camera-control module 828, which generates control signals for the cameras 102, 104 to capture images based on the pulsing of the light sources, thereby enhancing contrast between the object of interest and background; and a contrast-enhancing module 830, which regulates the contrast levels of the captured images. In addition, the memory 804 may include other module(s) 832 for facilitating the computer system 800 to achieve various functions as described in various embodiments herein. Thus, the light-control module 826 may support time multiplexing of image acquisition using different light sources with the same or different wavelengths, and/or may control the light sources to enhance contrast through comparison of differently illuminated images as described below; and the camera-control module 828 may operate the cameras to obtain comparison images to remove noise from a properly exposed image.

Display 808, speakers 809, keyboard 810, and mouse 811 can be used to facilitate user interaction with computer system 800. These components can be of generally conventional design or modified as desired to provide any type of user interaction. In some embodiments, results of motion capture using camera interface 806 and mocap program 814 can be interpreted as user input. For example, a user can perform hand gestures that are analyzed using mocap program 814, and the results of this analysis can be interpreted as an instruction to some other program executing on processor 800 (e.g., a web browser, word processor, or other application). Thus, by way of illustration, a user might use upward or downward swiping gestures to “scroll” a webpage currently displayed on display 808, to use rotating gestures to increase or decrease the volume of audio output from speakers 809, and so on.

It will be appreciated that computer system 800 is illustrative and that variations and modifications are possible. Computer systems can be implemented in a variety of form factors, including server systems, desktop systems, laptop systems, tablets, smart phones, e-readers or personal digital assistants, and so on. A particular implementation may include other functionality not described herein, e.g., wired and/or wireless network interfaces, media playing and/or recording capability, etc. In some embodiments, one or more cameras may be built into the computer rather than being supplied as separate components. Further, an image analyzer can be implemented using only a subset of computer system components (e.g., as a processor executing program code, an ASIC, or a fixed-function digital signal processor, with suitable I/O interfaces to receive image data and output analysis results).

While computer system 800 is described herein with reference to particular blocks, it is to be understood that the blocks are defined for convenience of description and are not intended to imply a particular physical arrangement of component parts. Further, the blocks need not correspond to physically distinct components. To the extent that physically distinct components are used, connections between components (e.g., for data communication) can be wired and/or wireless as desired.

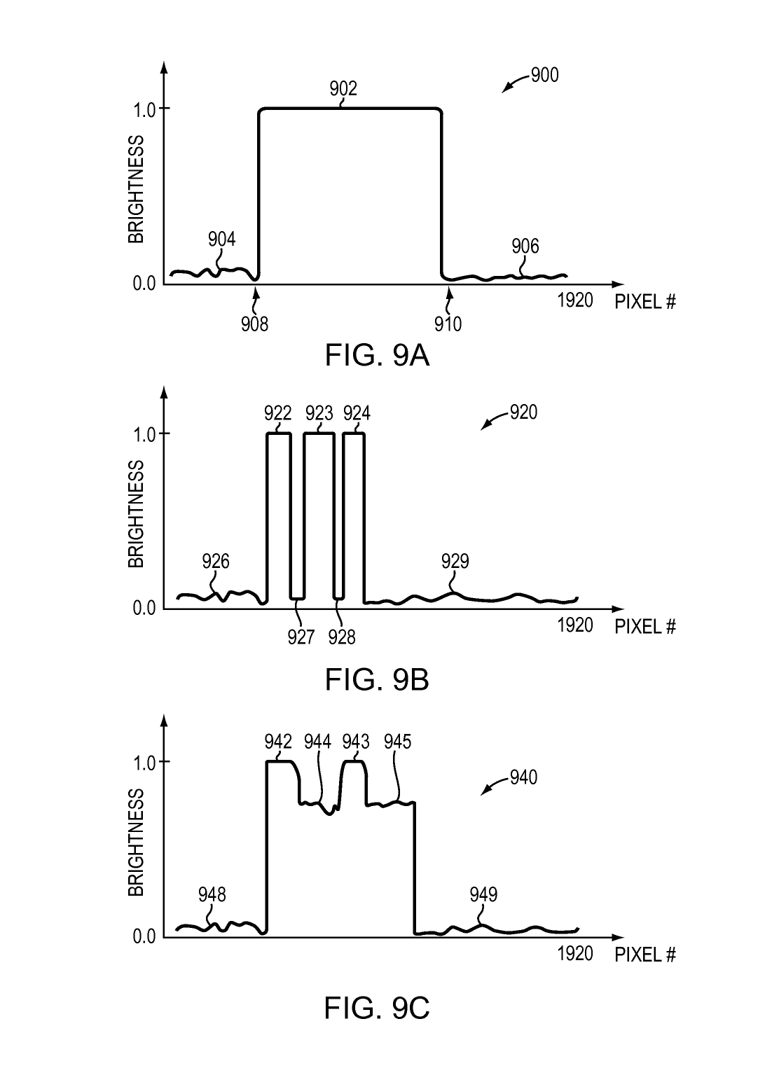

Execution of object detection module 822 by processor 802 can cause processor 802 to operate camera interface 806 to capture images of an object and to distinguish object pixels from background pixels by analyzing the image data. FIGS. 9A-9C are three different graphs of brightness data for rows of pixels that may be obtained according to various embodiments of the present invention. While each graph illustrates one pixel row, it is to be understood that an image typically contains many rows of pixels, and a row can contain any number of pixels; for instance, an HD video image can include 1080 rows having 1920 pixels each.

FIG. 9A illustrates brightness data 900 for a row of pixels in which the object has a single cross-section, such as a cross-section through a palm of a hand. Pixels in region 902, corresponding to the object, have high brightness while pixels in regions 904 and 906, corresponding to background, have considerably lower brightness. As can be seen, the object's location is readily apparent, and the locations of the edges of the object (at 908 at 910) are easily identified. For example, any pixel with brightness above 0.5 can be assumed to be an object pixel, while any pixel with brightness below 0.5 can be assumed to be a background pixel.

FIG. 9B illustrates brightness data 920 for a row of pixels in which the object has multiple distinct cross-sections, such as a cross-section through fingers of an open hand. Regions 922, 923, and 924, corresponding to the object, have high brightness while pixels in regions 926-929, corresponding to background, have low brightness. Again, a simple threshold cutoff on brightness (e.g., at 0.5) suffices to distinguish object pixels from background pixels, and the edges of the object can be readily ascertained.

FIG. 9C illustrates brightness data 940 for a row of pixels in which the distance to the object varies across the row, such as a cross-section of a hand with two fingers extending toward the camera. Regions 942 and 943 correspond to the extended fingers and have highest brightness; regions 944 and 945 correspond to other portions of the hand and are slightly less bright; this can be due in part to being farther away in part to shadows cast by the extended fingers. Regions 948 and 949 are background regions and are considerably darker than hand-containing regions 942-945. A threshold cutoff on brightness (e.g., at 0.5) again suffices to distinguish object pixels from background pixels. Further analysis of the object pixels can also be performed to detect the edges of regions 942 and 943, providing additional information about the object's shape.

It will be appreciated that the exemplary data shown in FIGS. 9A-9C is illustrative. In some embodiments, it may be desirable to adjust the intensity of light sources 108, 110 such that an object at an expected distance (e.g., r_{O} in FIG. 1) will be overexposed—that is, many if not all of the object pixels will be fully saturated to a brightness level of 1.0. (The actual brightness of the object may in fact be higher.) While this may also make the background pixels somewhat brighter, the 1/r² falloff of light intensity with distance still leads to a ready distinction between object and background pixels as long as the intensity is not set so high that background pixels also approach the saturation level. As FIGS. 9A-9C illustrate, use of lighting directed at the object to create strong contrast between object and background allows the use of simple and fast algorithms to distinguish between background pixels and object pixels, which can be particularly useful in real-time motion-capture systems. Simplifying the task of distinguishing background and object pixels can also free up computing resources for other motion-capture tasks (e.g., reconstructing the object's position, shape, surface characteristics, and/or motion).

Refer now to FIG. 10, which illustrates a process 1000 for identifying the location of an object in an image according to an embodiment of the present invention. Process 1000 can be implemented, e.g., in system 100 of FIG. 1. At block 1002, light sources 108, 110 are turned on. At block 1004, one or more images are captured using cameras 102, 104. In some embodiments, one image from each camera is captured. In other embodiments, a sequence of images is captured from each camera. The images from the two cameras can be closely correlated in time (e.g., simultaneous to within a few milliseconds in an embodiment) so that correlated images from the two cameras can be used to determine the 3D location of the object.

At block 1006, a threshold pixel brightness is applied to distinguish object pixels from background pixels. Block 1006 can also include identifying locations of edges of the object based on transition points between background and object pixels. In some embodiments, each pixel is first classified as either object or background based on whether it exceeds the threshold brightness cutoff. For example, as shown in FIGS. 9A-9C, a cutoff at a saturation level of 0.5 can be used. Once the pixels are classified, edges can be detected by finding locations where background pixels are adjacent to object pixels. In some embodiments, to avoid noise artifacts, the regions of background and object pixels on either side of the edge may be required to have a certain minimum size (e.g., 2, 4 or 8 pixels).

In other embodiments, edges can be detected without first classifying pixels as object or background. For example, Δβ can be defined as the difference in brightness between adjacent pixels, and |Δβ| above a threshold (e.g., 0.3 or 0.5 in terms of the saturation scale) can indicate a transition from background to object or from object to background between adjacent pixels. (The sign of Δβ can indicate the direction of the transition.) In some instances where the object's edge is actually in the middle of a pixel, there may be a pixel with an intermediate value at the boundary. This can be detected, e.g., by computing two brightness values for a pixel i:βL=(βi+βi−1)/2 and βR=(βi+(βi+1)/2, where pixel (i−1) is to the left of pixel i and pixel (i+1) is to the right of pixel i. If pixel i is not near an edge, |βL−βR| will generally be close to zero; if pixel is near an edge, then |βL−βR| will be closer to 1, and a threshold on |βL−βR| can be used to detect edges.

In some instances, one part of an object may partially occlude another in an image; for example, in the case of a hand, a finger may partly occlude the palm or another finger. Occlusion edges that occur where one part of the object partially occludes another can also be detected based on smaller but distinct changes in brightness once background pixels have been eliminated. FIG. 9C illustrates an example of such partial occlusion, and the locations of occlusion edges are apparent.

Detected edges can be used for numerous purposes. For example, as previously noted, the edges of the object as viewed by the two cameras can be used to determine an approximate location of the object in 3D space. The position of the object in a 2D plane transverse to the optical axis of the camera can be determined from a single image, and the offset (parallax) between the position of the object in time-correlated images from two different cameras can be used to determine the distance to the object if the spacing between the cameras is known.

Further, the position and shape of the object can be determined based on the locations of its edges in time-correlated images from two different cameras, and motion (including articulation) of the object can be determined from analysis of successive pairs of images. Examples of techniques that can be used to determine an object's position, shape and motion based on locations of edges of the object are described in the above-referenced '485 application. Those skilled in the art with access to the present disclosure will recognize that other techniques for determining position, shape and motion of an object based on information about the location of edges of the object can also be used.

In some embodiments, light sources 108, 110 can be operated in a pulsed mode rather than being continually on. This can be useful, e.g., if light sources 108, 110 have the ability to produce brighter light in a pulse than in a steady-state operation. FIG. 11 illustrates a timeline in which light sources 108, 110 are pulsed on at regular intervals as shown at 1102. The shutters of cameras 102, 104 can be opened to capture images at times coincident with the light pulses as shown at 1104. Thus, an object of interest can be brightly illuminated during the times when images are being captured.

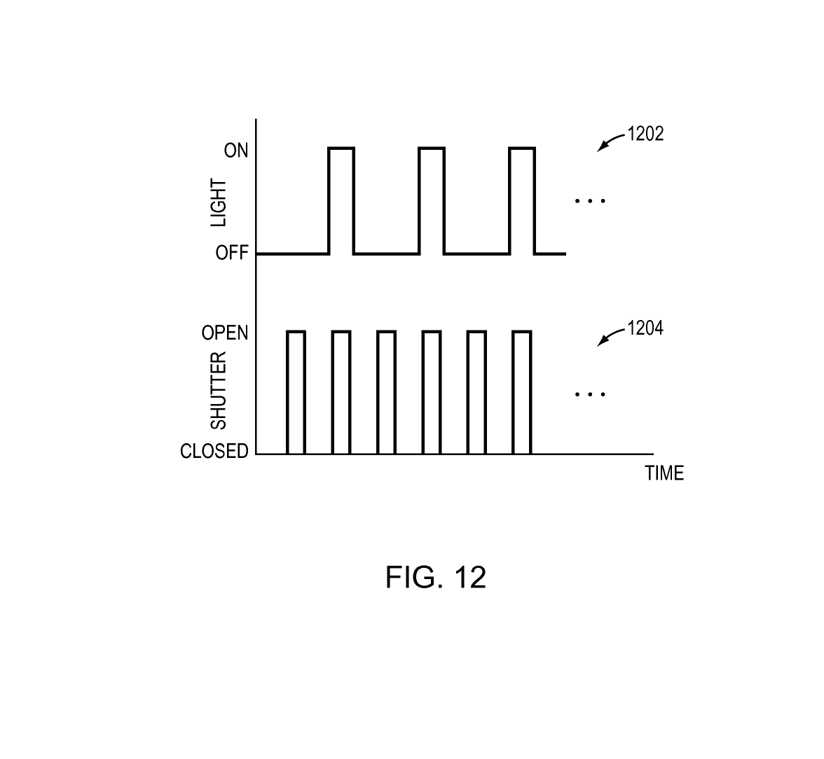

In some embodiments, the pulsing of light sources 108, 110 can be used to further enhance contrast between an object of interest and background by comparing images taken with lights 108, 110 on and images taken with lights 108, 110 off. FIG. 12 illustrates a timeline in which light sources 108, 110 are pulsed on at regular intervals as shown at 1202, while shutters of cameras 102, 104 are opened to capture images at times shown at 1204. In this case, light sources 108, 110 are “on” for every other image. If the object of interest is significantly closer than background regions to light sources 108, 110, the difference in light intensity will be stronger for object pixels than for background pixels. Accordingly, comparing pixels in successive images can help distinguish object and background pixels.

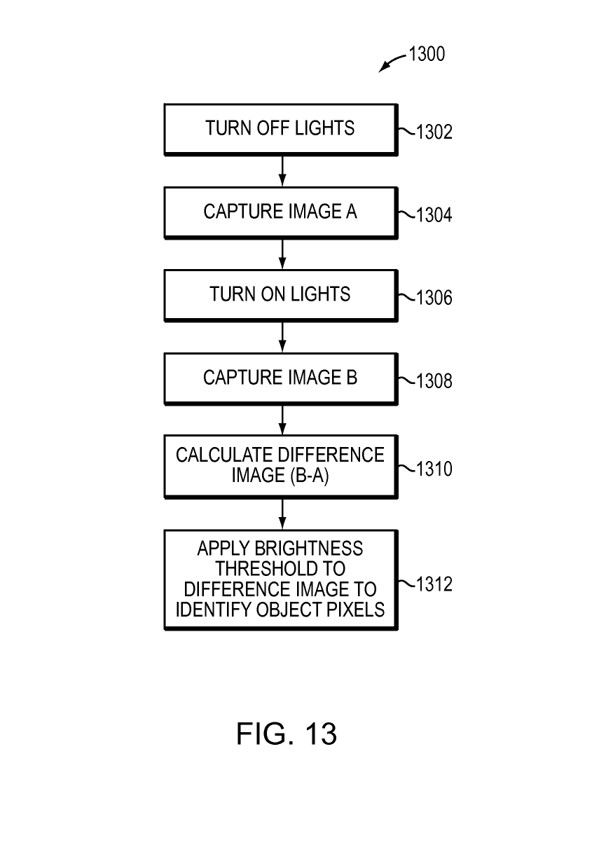

FIG. 13 is a flow diagram of a process 1300 for identifying object edges using successive images according to an embodiment of the present invention. At block 1302, the light sources are turned off, and at block 1304 a first image (A) is captured. Then, at block 1306, the light sources are turned on, and at block 1308 a second image (B) is captured. At block 1310, a “difference” image B−A is calculated, e.g., by subtracting the brightness value of each pixel in image A from the brightness value of the corresponding pixel in image B. Since image B was captured with lights on, it is expected that B−A will be positive for most pixels. In some embodiments, the light sources are not switched on and off during image capture. Instead, for example, the first and second images may be acquired using two concurrently active light sources, each emitting light at a different wavelength; and/or two types of filters, each allowing transmission of different light wavelengths; and/or two different types of image light-sensor pixels. In addition, the first and second images may be captured under different lighting conditions, including, for example, different exposure times and/or different sensor settings.

At block 1312, a threshold can be applied to the difference image (B−A) to identify object pixels, with (B−A) above a threshold being associated with object pixels and (B−A) below the threshold being associated with background pixels. Object edges can then be defined by identifying where object pixels are adjacent to background pixels, as described above. Object edges can be used for purposes such as position and/or motion detection, as described above.

Contrast-based object detection as described herein with reference to embodiments can be applied in situations including objects of interest expected to be significantly closer (e.g., half the distance) to the light source(s) than background objects. One such application relates to the use of motion-detection as user input to interact with a computer system. For example, the user may point to the screen or make other hand gestures, which can be interpreted by the computer system as input.

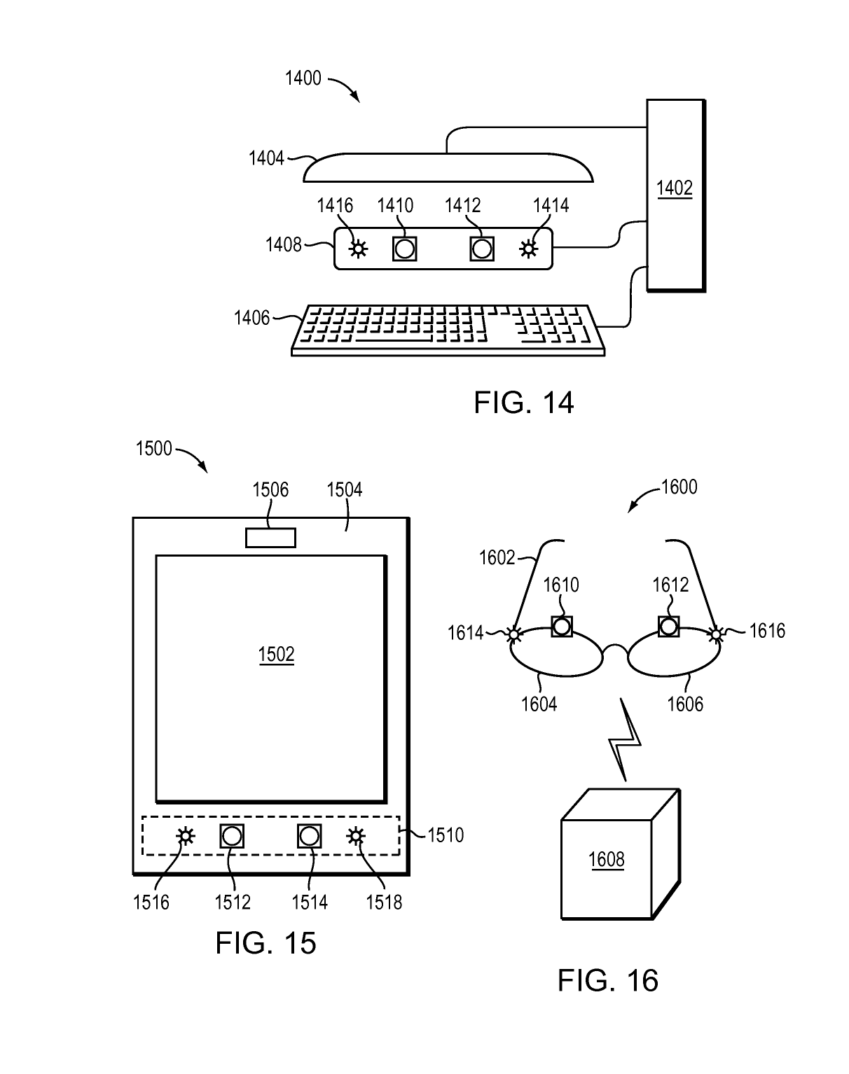

A computer system 1400 incorporating a motion detector as a user input device according to an embodiment of the present invention is illustrated in FIG. 14. Computer system 1400 includes a desktop box 1402 that can house various components of a computer system such as processors, memory, fixed or removable disk drives, video drivers, audio drivers, network interface components, and so on. A display 1404 is connected to desktop box 1402 and positioned to be viewable by a user. A keyboard 1406 is positioned within easy reach of the user's hands. A motion-detector unit 1408 is placed near keyboard 1406 (e.g., behind, as shown or to one side), oriented toward a region in which it would be natural for the user to make gestures directed at display 1404 (e.g., a region in the air above the keyboard and in front of the monitor). Cameras 1410, 1412 (which can be similar or identical to cameras 102, 104 described above) are arranged to point generally upward, and light sources 1414, 1416 (which can be similar or identical to light sources 108, 110 described above) are arranged to either side of cameras 1410, 1412 to illuminate an area above motion-detector unit 1408. In one embodiment, the cameras 1410, 1412 and the light sources 1414, 1416 are substantially coplanar, however alternative embodiments include non-coplanar light sources. This configuration prevents the appearance of shadows that can, for example, interfere with edge detection (as can be the case were the light sources located between, rather than flanking, the cameras). A filter, not shown, can be placed over the top of motion-detector unit 808 (or just over the apertures of cameras 1410, 1412) to filter out light outside a band around the peak frequencies of light sources 1414, 1416.

In the embodiment illustrated in FIG. 14, when the user moves a hand or other object (e.g., a pencil) in the field of view of cameras 1410, 1412, the background will likely include a ceiling and/or various ceiling-mounted fixtures. The user's hand can be for example 10-20 cm above motion detector 1408, while the ceiling may be for example five to ten times that distance (or more). Illumination from light sources 1414, 1416 will therefore be much more intense on the user's hand than on the ceiling, and the techniques described herein with reference to embodiments can provide for relatively reliable distinguishing of object pixels from background pixels in images captured by cameras 1410, 1412. If non-visible (e.g., infrared) light is used, the user will not be distracted or disturbed by the light.

Computer system 1400 can utilize the architecture shown in FIG. 1 or variants thereof. For example, cameras 1410, 412 of motion-detector unit 1408 can provide image data to desktop box 1402, and image analysis and subsequent interpretation can be performed using the processors and other components housed within desktop box 1402. Alternatively, motion-detector unit 1408 can incorporate processors or other components to perform some or all stages of image analysis and interpretation. For example, motion-detector unit 1408 can include a processor (programmable or fixed-function) that implements one or more of the processes described above to distinguish between object pixels and background pixels. In this case, motion-detector unit 1408 can send a reduced representation of the captured images (e.g., a representation with all background pixels zeroed out) to desktop box 1402 for further analysis and interpretation. A particular division of computational tasks between a processor inside motion-detector unit 1408 and a processor inside desktop box 1402 is not required.

Some embodiments can employ other techniques to discriminate between object pixels and background pixels alone or in conjunction with discriminating pixels by absolute brightness levels. For example, where knowledge of object shape exists, the pattern of brightness falloff can be utilized to detect the object in an image even without explicit detection of object edges. On rounded objects (such as hands and fingers), for example, the 1/r² relationship produces Gaussian or near-Gaussian brightness distributions near the centers of the objects; imaging a cylinder illuminated by an LED for example and disposed perpendicularly with respect to a camera results in an image having a bright center line corresponding to the cylinder axis, with brightness falling off to each side (around the cylinder circumference). Fingers are approximately cylindrical, and by identifying these Gaussian peaks, it is possible to locate fingers even in situations where the background is close and the edges are not visible due to the relative brightness of the background (either due to proximity or the fact that it may be actively emitting infrared light). The term “Gaussian” is used broadly herein to connote a bell-shaped curve that is typically symmetric, and is not limited to curves explicitly conforming to a Gaussian function.

FIG. 15 illustrates a tablet computer 1500 incorporating a motion detector according to an embodiment of the present invention. Tablet computer 1500 has a housing, the front surface of which incorporates a display screen 1502 surrounded by a bezel 1504. One or more control buttons 1506 can be incorporated into bezel 1504. Within the housing, e.g., behind display screen 1502, tablet computer 1500 can have various conventional computer components (processors, memory, network interfaces, etc.). A motion detector 1510 can be implemented using cameras 1512, 1514 (e.g., similar or identical to cameras 102, 104 of FIG. 1) and light sources 1516, 1518 (e.g., similar or identical to light sources 108, 110 of FIG. 1) mounted into bezel 1504 and oriented toward the front surface so as to capture motion of a user positioned in front of tablet computer 1500.

When the user moves a hand or other object in the field of view of cameras 1512, 1514, the motion is detected as described above. In this case, the background is likely to be the user's own body, at a distance of roughly 25-30 cm from tablet computer 1500. The user may hold a hand or other object at a short distance from display 1502, e.g., 5-10 cm. As long as the user's hand is significantly closer than the user's body (e.g., half the distance) to light sources 1516, 1518, the illumination-based contrast enhancement techniques described herein with reference to embodiments can provide for distinguishing object pixels from background pixels. The image analysis and subsequent interpretation as input gestures can be done within tablet computer 1500 (e.g., leveraging the main processor to execute operating-system or other software to analyze data obtained from cameras 1512, 1514). The user can thus interact with tablet 1500 using gestures in 3D space.

A goggle system 1600, as shown in FIG. 16, may also incorporate a motion detector according to an embodiment of the present invention. Goggle system 1600 can be used, e.g., in connection with virtual-reality and/or augmented-reality environments. Goggle system 1600 includes goggles 1602 that are wearable by a user, similar to conventional eyeglasses. Goggles 1602 include eyepieces 1604, 1606 that can incorporate small display screens to provide images to the user's left and right eyes, e.g., images of a virtual reality environment. These images can be provided by a base unit 1608 (e.g., a computer system) that is in communication with goggles 1602, either via a wired or wireless channel. Cameras 1610, 1612 (e.g., similar or identical to cameras 102, 104 of FIG. 1) can be mounted in a frame section of goggles 1602 such that they do not obscure the user's vision. Light sources 1614, 1616 can be mounted in the frame section of goggles 1602 to either side of cameras 1610, 1612. Images collected by cameras 1610, 1612 can be transmitted to base unit 1608 for analysis and interpretation as gestures indicating user interaction with the virtual or augmented environment. (In some embodiments, the virtual or augmented environment presented through eyepieces 1604, 1606 can include a representation of the user's hand and/or other obect(s), and that representation can be based on the images collected by cameras 1610, 1612.)

When the user gestures using a hand or other object in the field of view of cameras 1608, 1610, the motion is detected as described above. In this case, the background is likely to be a wall of a room the user is in, and the user will most likely be sitting or standing at some distance from the wall. As long as the user's hand is significantly closer than the user's body (e.g., half the distance) to light sources 1612, 1614, the illumination-based contrast enhancement techniques described herein with reference to embodiments can provide for distinguishing object pixels from background pixels. The image analysis and subsequent interpretation as input gestures can be done within base unit 1608.

It will be appreciated that the motion-detector implementations of the embodiments shown in FIGS. 14-16 are illustrative and that many variations and modifications are possible. For example, a motion detector or components thereof can be combined in a single housing with other user input devices, such as a keyboard or trackpad; and/or incorporated into a familiar pointing device to make such device work in a “touch-less” manner (e.g., touch-less joystick, touch-less computer mouse, etc.). As another example, a motion detector can be incorporated into a laptop computer, e.g., with upward-oriented cameras and light sources built into the same surface as the laptop keyboard (e.g., to one side of the keyboard or in front of or behind it) or with front-oriented cameras and light sources built into a bezel surrounding the laptop's display screen. As still another example, a wearable motion detector can be implemented, e.g., as a headband or headset or incorporated into a helmet or other headgear that does not include active displays or optical components.

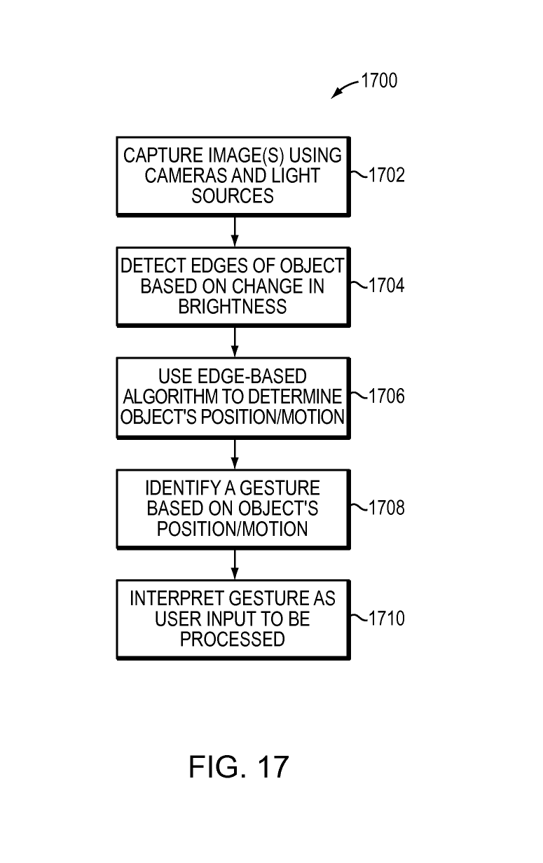

As illustrated in FIG. 17, motion information can be used as user input to control a computer system or other system according to an embodiment of the present invention. Process 1700 can be implemented, e.g., integrally and/or non-integrally added to computer systems such as those shown in FIGS. 14-16. At block 1702, images are captured using the light sources and cameras of the motion detector. As described above, capturing the images can include using the light sources to illuminate the field of view of the cameras such that objects closer to the light sources (and the cameras) are more brightly illuminated than objects farther away. In addition, images may be captured using multiple types of filters, multiple types of image-sensing pixels and/or multiple light exposure intervals from different types, and/or different numbers of, light sources.

At block 1704, the captured images are analyzed to detect edges of the object based on changes in brightness. For example, as described above, this analysis can include comparing the brightness of each pixel to a threshold, detecting transitions in brightness from a low level to a high level across adjacent pixels, and/or comparing successive images captured with and without illumination by the light sources. At block 1706, an edge-based algorithm is used to determine the object's position and/or motion. This algorithm can be, for example, any of the tangent-based algorithms described in the above-referenced '485 application; other algorithms can also be used.

At block 1708, a gesture is identified based on the object's position and/or motion. For example, a library of gestures can be defined based on the position and/or motion of a user's fingers. A “tap” can be defined based on a fast motion of an extended finger toward a display screen. A “trace” can be defined as motion of an extended finger in a plane roughly parallel to the display screen. An inward pinch can be defined as two extended fingers moving closer together and an outward pinch can be defined as two extended fingers moving farther apart. A “spin of a knob” can be defined as motion of a finger(s) and or hand in a continuing spiral. Swipe gestures can be defined based on movement of the entire hand in a particular direction (e.g., up, down, left, right) and different swipe gestures can be further defined based on the number of extended fingers (e.g., one, two, all). Other gestures can also be defined. New gestures can be built from combinations of existing gestures and/or with incorporating new motions. By comparing a detected motion to the library, a particular gesture associated with detected position and/or motion can be determined.

At block 1710, the gesture is interpreted as user input, which the computer system can process. The particular processing generally depends on application programs currently executing at least in part on the computer system and a context including how those programs are configured to respond to particular inputs. For example, a tap in a browser program can be interpreted as selecting a link toward which the finger is pointing. A tap in a word-processing program can be interpreted as placing the cursor at a position where the finger is pointing or as selecting a menu item or other graphical control element that may be visible on the screen. The particular gestures and interpretations can be determined at the level of operating systems and/or applications as desired, and no particular interpretation of any gesture is required.

Full-body motion can be captured and used in embodiments. In such embodiments, the analysis and reconstruction advantageously occurs in approximately real-time (e.g., times comparable to human reaction times), so that the user experiences a natural interaction with the equipment. In other applications, motion capture can be used for digital rendering that is not done in real time, e.g., for computer-animated movies or the like; in such cases, the analysis can take as long as desired.

Embodiments described herein provide for efficient discrimination between object and background in captured images by exploiting a variety of physical properties of light (i.e., the decrease of light intensity with distance). In one embodiment, by brightly illuminating the object using one or more light sources that are significantly closer to the object than to the background (e.g., by a factor of two or more), the contrast between object and background can be increased. In some embodiments, filters can be used to remove light from sources other than the intended sources. Using non-visible (e.g., infrared) light can reduce unwanted “noise” or bright spots from visible light sources likely to be present in the environment where images are being captured and can also reduce distraction to users (who presumably cannot see infrared).

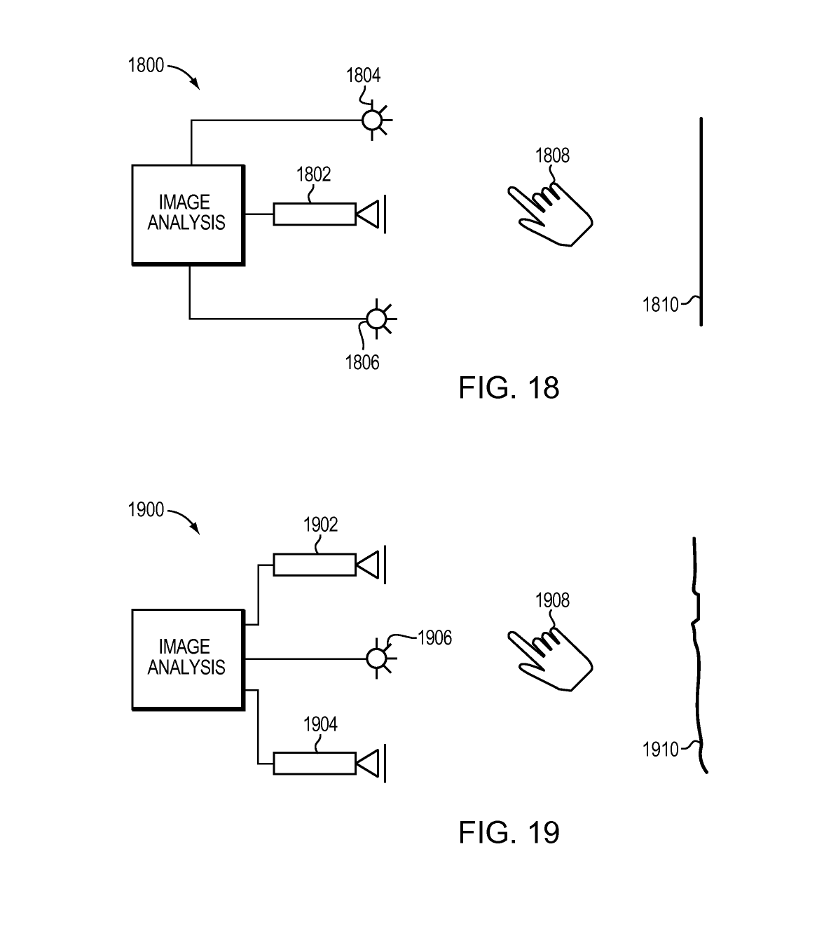

Some embodiments described above provide for two light sources, one disposed to either side of the cameras used to capture images of the object of interest. This arrangement can be useful where the position and motion analysis relies on knowledge of the object's edges as seen from each camera, as the light sources will illuminate those edges. However, other arrangements can also be used. For example, FIG. 18 illustrates a system 1800 with a single camera 1802 and two light sources 1804, 1806 disposed to either side of camera 1802. This arrangement can be used to capture images of object 1808 and shadows cast by object 1808 against a flat background region 1810. In this embodiment, object pixels and background pixels can be readily distinguished. In addition, provided that background 1810 is not too far from object 1808, sufficient contrast between pixels in the shadowed background region and pixels in the unshadowed background region can provide for discrimination between the two. Position and motion detection algorithms using images of an object and its shadows are described in the above-referenced '485 application and system 1800 can provide input information useful in conjunction therewith, including the location of edges of the object and its shadows.

FIG. 19 illustrates another system 1900 with two cameras 1902, 1904 and one light source 1906 disposed between the cameras. System 1900 can capture images of an object 1908 against a background 1910. System 1900 is generally less reliable for edge illumination than system 100 of FIG. 1; however, not all algorithms for determining position and motion rely on precise knowledge of the edges of an object. Accordingly, system 1900 can be used, e.g., with edge-based algorithms in situations where less accuracy is required. System 1900 can also be used with non-edge-based algorithms.

While the invention has been described with respect to specific embodiments, one skilled in the art will recognize that numerous modifications are possible. The number and arrangement of cameras and light sources can be varied. The cameras' capabilities, including frame rate, spatial resolution, and intensity resolution, can also be varied as desired. The light sources can be operated in continuous or pulsed mode. The systems described herein with reference to embodiments can provide images with enhanced contrast between object and background to facilitate distinguishing between the two, and this information can be used for numerous purposes, of which position, recognition, surface characterization, and/or motion detection are just some among many possibilities.

Threshold cutoffs and other specific criteria for distinguishing object from background can be adapted in embodiments for particular cameras and particular environments. As noted above, contrast is expected to increase as the ratio r_{B}/r_{O} increases. In some embodiments, the system can be calibrated in a particular environment, e.g., by adjusting light-source brightness, threshold criteria, and so on. Some embodiments will employ simple criteria that can be implemented in relatively faster algorithms thereby enabling freeing processing power in a given system for other uses.

Any type of object can be the subject of motion capture using one or more of the described techniques, and various implementation specific details can be chosen to suit a particular type of object(s). For example, the type and positions of cameras and/or light sources can be selected based on the size of the object whose motion is to be captured and/or the space in which motion is to be captured. Analysis techniques in accordance with embodiments of the present invention can be implemented as algorithms in any suitable computer language and executed on programmable processors, and/or some or all of the algorithms can be implemented in fixed-function logic circuits, and/or combinations thereof. Such circuits can be designed and fabricated using conventional or other tools.

Embodiments may employed in a variety of application areas, such as for example and without limitation consumer applications including interfaces for computer systems, laptops, tablets, television, game consoles, set top boxes, telephone devices and/or interfaces to other devices; medical applications including controlling devices for performing robotic surgery, medical imaging systems and applications such as CT, ultrasound, x-ray, MRI or the like, laboratory test and diagnostics systems and/or nuclear medicine devices and systems; prosthetics applications including interfaces to devices providing assistance to persons under handicap, disability, recovering from surgery, and/or other infirmity; defense applications including interfaces to aircraft operational controls, navigations systems control, on-board entertainment systems control and/or environmental systems control; automotive applications including interfaces to automobile operational systems control, navigation systems control, on-board entertainment systems control and/or environmental systems control; security applications including, monitoring secure areas for suspicious activity or unauthorized personnel; manufacturing and/or process applications including interfaces to assembly robots, automated test apparatus, work conveyance devices such as conveyors, and/or other factory floor systems and devices, genetic sequencing machines, semiconductor fabrication related machinery, chemical process machinery and/or the like; and/or combinations thereof.

Computer programs incorporating various features of the present invention may be encoded on various computer readable storage media; suitable media include magnetic disk or tape, optical storage media such as compact disk (CD) or DVD (digital versatile disk), flash memory, and any other non-transitory medium capable of holding data in a computer-readable form. Computer-readable storage media encoded with the program code may be packaged with a compatible device or provided separately from other devices. In addition program code may be encoded and transmitted via wired, optical, and/or wireless networks conforming to a variety of protocols, including the Internet, thereby allowing distribution, e.g., via Internet download and/or provided on-demand as web-services.

As used herein, the term “substantially” or “approximately” means±10% (e.g., by weight or by volume), and in some embodiments, ±5%. The term “consists essentially of” means excluding other materials that contribute to function, unless otherwise defined herein. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

Thus, although the invention has been described with respect to specific embodiments, it will be appreciated that the invention is intended to cover all modifications and equivalents within the scope of the following claims.

What is claimed is:

1. A method of improving an image of an object for machine control, comprising:
illuminating the object with electromagnetic radiation having a first optical characteristic;
selectively sensitizing a first subset of optically sensitive picture elements of a sensor to the first optical characteristic and selectively sensitizing a second subset of optically sensitive picture elements of the sensor to a second optical characteristic;
capturing an image of the object, the image including a first image information subset derived from the first subset of optically sensitive picture elements and a second image information subset derived from the second subset of optically sensitive picture elements; and
removing noise from the image to form an improved image by determining a difference between the first image information subset and the second image information subset.

2. The method of claim 1, further comprising:
analyzing the improved image to determine gesture information for controlling a machine.

3. The method of claim 1, wherein removing noise from the image includes:
comparing amplitude ratios between corresponding pixels of the first image information subset and the second image information subset captured by different sets of sensor picture elements.

4. The method of claim 1, wherein the optical characteristic includes:
at least one of a wavelength, frequency, polarization.

5. The method of claim 1, wherein selectively sensitizing a first subset of optically sensitive picture elements of a sensor to the first optical characteristic and selectively sensitizing a second subset of optically sensitive picture elements of the sensor to a second optical characteristic includes:
applying a first filter to the first subset of optically sensitive picture elements of the sensor, the filter permitting detection of electromagnetic radiation having a wavelength proximate to the first optical characteristic.

6. The method of claim 5, wherein applying a first filter to the first subset of optically sensitive picture elements of the sensor, includes:
applying the first filter to a first set of alternating pixel rows and/or columns in an interlaced fashion or in a mixed axis pattern.

7. The method of claim 5, wherein illuminating the object with electromagnetic radiation having a first optical characteristic includes:
illuminating with a light source having a dominant wavelength; and wherein the first filter permits detection of electromagnetic radiation having a wavelength proximate to the dominant wavelength; and
applying a second filter that does not permit detection of the dominant wavelength to the second subset of optically sensitive picture elements of the sensor.

8. The method of claim 1, wherein selectively sensitizing a first subset of optically sensitive picture elements of a sensor to the first optical characteristic and selectively sensitizing a second subset of optically sensitive picture elements of the sensor to a second optical characteristic includes:
controlling a subset of optically sensitive picture elements of the sensor to respond electrically to electromagnetic radiation having a wavelength including at least the first optical characteristic.

9. The method of claim 1, wherein selectively sensitizing a first subset of optically sensitive picture elements of a sensor to the first optical characteristic and selectively sensitizing a second subset of optically sensitive picture elements of the sensor to a second optical characteristic includes: dynamically tuning a subset of optically sensitive picture elements of the sensor to respond electrically to electromagnetic radiation having a wavelength including at least the first optical characteristic.

10. An image capture and analysis system comprising:
a camera oriented toward a field of view, the camera comprising an image sensor comprising light-sensing pixels;
a first type of filter applicable to a first plurality of the pixels;
a second type of filter applicable to a second plurality of pixels, different from the first plurality of pixels, to provide an image optically different from an image taken with the first type of filter; and
an image analyzer coupled to the camera and configured to:
capture using the camera a plurality of images including a first image corresponding to the first plurality of pixels and a second image corresponding to the second plurality of pixels; and
determine based at least in part upon the first image and the second image, pixels corresponding to an object of interest in the field of view.

11. The system of claim 10, further comprising a light source having a dominant wavelength; and
wherein the first filter type allows transmission of the dominant wavelength whereas the second filter type does not allow transmission of the dominant wavelength.

12. The system of claim 10, further comprising a light source having a dominant wavelength; and
wherein the first filter type allows transmission of wavelengths greater than a threshold wavelength no longer than the dominant wavelength, whereas the second filter type passes wavelengths more than a threshold amount below the dominant wavelength.

13. The system of claim 12, wherein the threshold wavelength is shorter than the dominant wavelength.

14. The system of claim 13, wherein the threshold amount is at least equal to a difference between the dominant wavelength and the threshold wavelength.

15. The system of claim 10, further comprising a light source having a dominant wavelength; and
wherein the first filter type allows transmission of wavelengths greater than a threshold wavelength no longer than the dominant wavelength, whereas the second filter type passes wavelengths more than a threshold amount above the dominant wavelength.

16. The system of claim 15, wherein the threshold wavelength is shorter than the dominant wavelength.

17. The system of claim 16, wherein the threshold amount is at least equal to a difference between the dominant wavelength and the threshold wavelength.

18. The system of claim 10, further comprising a light source having a dominant wavelength; and
wherein the first filter type allows transmission of wavelengths less than a threshold wavelength no shorter than the dominant wavelength, whereas the second filter type passes wavelengths more than a threshold amount above the dominant wavelength.

19. The system of claim 18, wherein the threshold wavelength is longer than the dominant wavelength.

20. The system of claim 19, wherein the threshold amount is at least equal to a difference between the dominant wavelength and the threshold wavelength.

21. The system of claim 20, wherein the first filter type passes wavelengths centered around the dominant wavelength with increasing attenuation above and below the dominant wavelength, and the second filter type passes wavelengths centered around a filter wavelength different from the dominant wavelength and with increasing attenuation above and below the filter wavelength.

22. The system of claim 21, wherein the filter wavelength is at least 50 nm above or below the dominant wavelength.

23. The system of claim 10, wherein the first and second filter types are applicable in an interlaced fashion to at least one of alternating pixel rows or alternating pixel columns.

24. The system of claim 10, wherein the first and second filter types apply to different pixels in a mixed-axis pattern.

25. The system of claim 10, wherein the first and second filter types apply to different numbers of pixels.

26. The system of claim 25, wherein images corresponding to the first and second filter types have an enhanced bit-depth.

27. The system of claim 10, further comprising a plurality of light sources emitting at least two optically distinct forms of light, the light sources having a predetermined geometry relative to the camera, the image analyzer detecting motion based at least in part on the known geometry and angular information embedded in the first and second images.

28. The system of claim 10, wherein the first and second images are captured substantially simultaneously.

29. The system of claim 10, wherein the first type of filter and second type of filter are arranged to pass light having different polarizations.

30. A non-transitory machine readable medium, storing one or more instructions which when executed by one or more processors cause the one or more processors to perform the following:
illuminating the object with electromagnetic radiation having a first optical characteristic;
capturing an image of the object, the image including a first image information subset derived from selectively sensitizing a first subset of optically sensitive picture elements of a sensor to the first optical characteristic and a second image information subset derived from selectively sensitizing a second subset of optically sensitive picture elements of the sensor to a second optical characteristic; and
removing noise from the image to form an improved image by determining a difference between the first image information subset and the second image information subset.
